(19) United States
(12) Patent Application Publication
(10) Pub. No.: US 2026/0139484 A1
(43) Pub. Date: May 21, 2026

(54) LIGHT-TRANSMITTING PANEL FOR BUILDINGS AND METHOD OF USING SAME

(71) Applicant: 9416-1999 QUÉBEC INC, Rosemere (CA)

(72) Inventor: Charles-Benoit GERMAIN, Rosemere (CA)

(21) Appl. No.: 18/705,749

(22) PCT Filed: Oct. 29, 2021
(86) PCT No.: PCT/CA2021/051538

§ 371 Date: Apr. 29, 2024

(51) Int. Cl. E04C 2/54; A01G 9/24; F21S 11/00; H02S 20/23

(52) U.S. Cl. CPC E04C 2/54; A01G 9/243; A01G 9/249; F21S 11/007; H02S 20/23

(57) ABSTRACT

A light-transmitting panel for a building such as a greenhouse. The panel includes a light-transmitting member positioned between an inner surface and an outer surface of the panel, the light-transmitting member including a plurality of light-transmitting devices (e.g., light pipes) and a thermal insulator at least partially surrounding the light-transmitting devices. Each of the light-transmitting devices includes a light-receiving portion, a light-emitting portion and a transmission portion between the light-receiving portion and the light-emitting portion. The panel may be connected to a frame along its perimeter. In some embodiments, sensors and/or functional components may be provided in connection with the panel and may be configured to exchange signals with an electronic system to provide monitoring and/or control functionality.

### CROSS-REFERENCE TO RELATED APPLICATIONS

This application is a U.S. National Stage Application of International Patent Application No. PCT/CA 2021/051538, filed Oct. 29, 2021, the entire disclosure of which is hereby incorporated by reference as if set forth herein.

### TECHNICAL FIELD

This disclosure generally relates to light-transmitting panels such as those that may be used for forming portions of walls and/or roofs of buildings, and more particularly to light-transmitting panels for forming walls and/or roofs of greenhouses.

### BACKGROUND

Buildings, such as greenhouses, often comprise light-transmitting wall and/or roof panels to transmit ambient light from outside the buildings to inside the buildings, e.g., to facilitate agriculture. However, most conventional light-transmitting panels exhibit high thermal conductivities, which may be problematic in certain environments. For instance, in environments where temperatures are generally low (e.g., in a polar climate, during winter, etc.), ambient temperatures may be lower than optimal temperatures for crops and the high thermal conductivity of conventional panels when used in existing greenhouses creates a need for heating. In environments where temperatures are generally high (e.g., in a tropical climate, during summer months), ambient temperatures may be higher than optimal temperatures for crops and the high thermal conductivity of conventional panels when used in existing greenhouses frequently creates a need for air conditioning so as not to negatively affect crop growth. Other conventional light-transmitting panels may be relatively thicker in order to reduce thermal conductivity; however this increased thickness reduces light transmittance capabilities and increases weight and manufacturing and transport costs.

Against the background described above, it is clear that there remains a need in the industry to provide improved light-transmitting panels that alleviate at least some of the deficiencies of conventional light-transmitting panels.

### SUMMARY

This summary is provided to introduce a selection of concepts in a simplified form that are further described below in the Detailed Description. This Summary is not intended to identify all key aspects and/or essential aspects of the claimed subject matter.

In accordance with various aspects of this disclosure, there is provided a light-transmitting panel for a building such as for example a greenhouse. The panel includes a plurality of light-transmitting devices (e.g., light pipes) arranged in a side-by-side configuration and a thermal insulator material at least partially surrounding the light-transmitting devices. Each of the light-transmitting devices may include a light-receiving portion, a light-emitting portion and a transmission portion between the light-receiving portion and the light-emitting portion. The panel may be connected to a frame along a perimeter of the panel.

For example, in accordance with an aspect of this disclosure, there is provided a light-transmitting panel for a building. The light-transmitting panel comprises: an inner surface, an outer surface and a perimeter surrounding the inner surface and outer surface; and a light-transmitting member positioned between the inner surface and the outer surface. The light-transmitting member comprises: a plurality of light transmitting devices positioned alongside one-another, each light transmitting devices including a light-receiving portion, a light-emitting portion and a transmission portion between the light-receiving portion and the light-emitting portion; and a thermal insulator at least partially surrounding the light-transmitting devices in the plurality of light transmitting devices.

In accordance with another aspect of this disclosure, there is provided a panel system comprising a plurality of light-transmitting panels for a building. Each light-transmitting panel comprises: an inner surface, an outer surface and a perimeter surrounding the inner surface and outer surface of the light-transmitting panel; a light-transmitting member positioned between the inner surface and the outer surface. The light-transmitting member comprises: a plurality of light transmitting devices positioned alongside one-another, each light transmitting device including a light-receiving portion, a light-emitting portion and a transmission portion between the light-receiving portion and the light-emitting portion; and a thermal insulator at least partially surrounding the light-transmitting devices in the plurality of light transmitting devices. Each light-transmitting panel comprises at least one sensor configured to sense a characteristic of an environment of the panel and generate a signal conveying a measurement of the characteristic. The panel system comprises a monitoring system in communication with said at least one sensor, the monitoring system comprising a processing apparatus configured for: receiving the signal conveying the measurement of the characteristic; and processing the signal and rendering a user interface on a display device in communication with the monitoring system, the user interface presenting information derived by processing the measurement of the characteristic.

In accordance with another aspect of this disclosure, there is provided an electronic monitoring system for a plurality of light-transmitting panels using in a building. The light-transmitting panel comprises at least one sensor configured to sense a characteristic of an environment of the panel and generate a signal conveying a measurement of the characteristic. The monitoring system is communication with said at least one sensor for receiving the signal conveying the measurement of the characteristic. The monitoring system comprises a processing apparatus for: receiving the signal conveying the measurement of the characteristic; and processing the signal and rendering a user interface on a display device in communication with the monitoring system, the user interface presenting information derived by processing the measurement of the characteristic.

The above-described light-transmitting panel may be used in a wide variety of practical building applications to provide walls, windows and/or roofing portions including, without being limited, for greenhouses, office buildings, industrial/commercial buildings, residential buildings and other architectural structures.

All features of exemplary embodiments which are described in this disclosure and are not mutually exclusive can be combined with one another. Elements of one embodiment or aspect can be utilized in the other embodiments/aspects without further mention.

These and other aspects of this disclosure will now become apparent to those of ordinary skill in the art upon review of a description of embodiments that follows in conjunction with accompanying drawings.

### BRIEF DESCRIPTION OF DRAWINGS

A detailed description of embodiments is provided below, by way of example only, with reference to drawings annexed hereto, in which:

FIG. 1 is perspective view of a greenhouse comprising light-transmitting panels in accordance with a specific embodiment;

FIG. 2 is a perspective view of one of the light-transmitting panels of the greenhouse shown in FIG. 1;

FIGS. 3 and 4 are exploded views of the light-transmitting panel of FIG. 2 showing frame members slidably engageable over the light-transmitting panel;

FIG. 5 is a cross-sectional view of the light-transmitting panel of FIG. 2;

FIG. 6 is a perspective view of a portion of the light-transmitting panel of FIG. 2 slidably engaging a frame member;

FIG. 7 shows a portion of an outer surface of the light-transmitting panel of FIG. 2;

FIG. 8 is a cross-sectional view of a portion of the light-transmitting panel of FIG. 2 showing different layers of the light-transmitting panel in accordance with a specific embodiment;

FIG. 9 shows trajectories of light beams hitting an outer surface of the light-transmitting panel of FIG. 2;

FIG. 10 shows trajectories of light beams hitting an inner surface of the light-transmitting panel of FIG. 2;

FIG. 11 are diagrams illustrating light-transmittance characteristics of the light-transmitting panel as a function of wavelength in accordance with a specific embodiment;

FIG. 12 shows a connection mechanism between a periphery of the light-transmitting panel of FIG. 2 and a railing system of a building in accordance with a specific embodiment;

FIG. 13 shows trajectories of light beams hitting an outer surface of the light-transmitting panel according to another embodiment wherein the light-transmitting panel comprises an outer filter;

FIG. 14 shows a block diagram of another embodiment wherein the light-transmitting panel comprises an outer filter comprises a photovoltaic cell connected to a battery;

FIG. 15 shows trajectories of light beams hitting an outer surface of the light-transmitting panel according to another embodiment wherein the light-transmitting panel comprises an inner filter;

FIG. 16 is a cross-sectional view of the light-transmitting panel according to another embodiment wherein the light-transmitting panel comprises photovoltaic cells;

FIG. 17 shows a block diagram of the photovoltaic cell of FIG. 16 connected to a battery;

FIG. 18 shows a perspective view of the light-transmitting panel according to another embodiment wherein the light-transmitting panel comprises a screen;

FIG. 19 shows a cross-sectional view of a portion of the light-transmitting panel of FIG. 18 comprising a support for the screen;

FIG. 20 shows a perspective view of an embodiment of the greenhouse comprising shutters over the panels;

FIG. 21 shows a cross-sectional view of the light-transmitting panel according to another embodiment wherein the light-transmitting panel comprises a lighting system and a heat dissipator;

FIG. 22 shows a cross-sectional view of a portion of the light-transmitting panel of FIG. 21 comprising a LED;

FIG. 23 shows a heat distribution of a portion of the light-transmitting panel of FIG. 21;

FIG. 24 shows a side view of an embodiment of the greenhouse comprising a monitoring system and light-transmitting panels having sensors in communication with the monitoring system;

FIG. 25 shows a block diagram of the monitoring system of FIG. 24;

FIG. 26 shows a block diagram of a processing apparatus of the monitoring system of FIG. 24;

FIG. 27 shows a block diagram of an interface of the processing apparatus of the monitoring system of FIG. 24;

FIG. 28 shows an embodiment of a display device in communication with the monitoring system of FIG. 24;

FIG. 29 shows a block diagram of the display device of FIG. 28;

FIG. 30 shows a block diagram of a user interface of the display device of FIG. 28;

FIG. 31 shows a block diagram of signals exchanged between the monitoring system and the display device of FIG. 28;

FIG. 32 shows a block diagram of an embodiment wherein the monitoring system of FIG. 24 is in communication with a screen;

FIG. 33 shows a block diagram of an embodiment wherein the monitoring system of FIG. 24 is in communication with an actuator of shutters;

FIG. 34 shows a block diagram of an embodiment wherein the monitoring system of FIG. 24 is in communication with a lighting system;

FIG. 35 shows a perspective view of an embodiment of the light-transmitting panel connected to frame members;

FIG. 36 shows a top view of the light-transmitting panel of claim 35;

FIG. 37 shows an exploded view of the light-transmitting panel of claim 35;

FIG. 38 shows a perspective view of an embodiment of a light-transmitting device of the light-transmitting panel of claim 35;

FIGS. 39 to 42 show a top view, a side view and exploded views of the light-transmitting device of FIG. 38; and

FIG. 43 shows a cross-sectional view of the light-transmitting device of FIG. 38 and shows trajectories of light beams hitting an outer surface of the light-transmitting device of FIG. 38.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION OF EMBODIMENTS

A detailed description of one or more specific embodiments of the invention is provided below along with accompanying Figures that illustrate principles of the invention. The invention is described in connection with such embodiments, but the invention is not limited to any specific embodiment. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

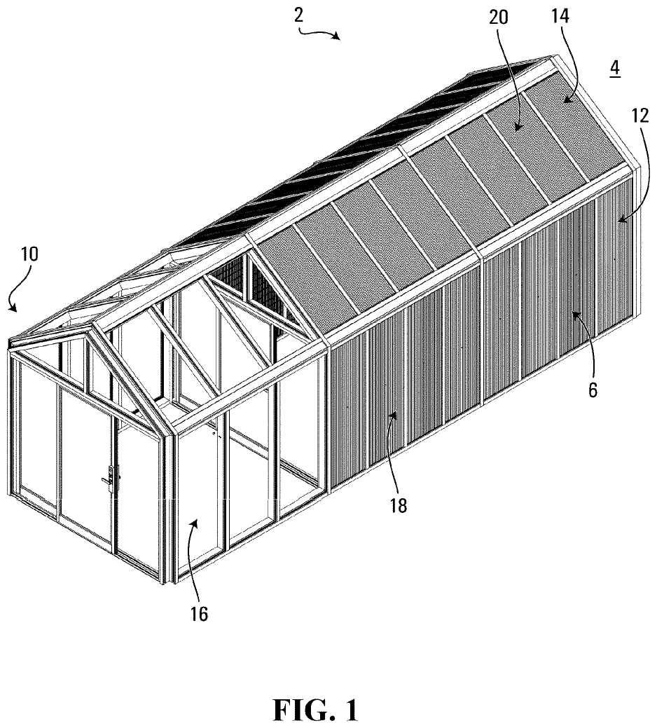

FIG. 1 shows a building 2 comprising a panel system comprising a frame structure 10 and a plurality of panels 20, according to one embodiment of the disclosure.

In this embodiment, the building 2 is a greenhouse and comprises an exterior 4 including a sun 3 and an interior 6. The greenhouse 2 comprises walls 12 and roof sections 14. The greenhouse 2 may comprise a lobby 16 configured to offer a shelter without being configured for growing crops. The greenhouse 2 may also comprise a room 18 for growing crops. In this embodiment, the walls 12 and roof sections 14 of the room 18 comprise frame structures 10 and panels 20. More particularly, in this embodiment, the walls 12 and roof sections 14 of the room 18 are entirely made of the frame structures 10 and panels 20. In this regard, each panel 20 may be viewed as a wall panel or a roof panel.

As further discussed below, each panel 20 may have translucent (i.e., light-transmitting) characteristics, thermal and dimensional characteristics that may improve efficiency of greenhouse. In particular, each panel 20 may have an increased light transmittance, may provide an increased heat insulation coefficient, and may be relatively thin.

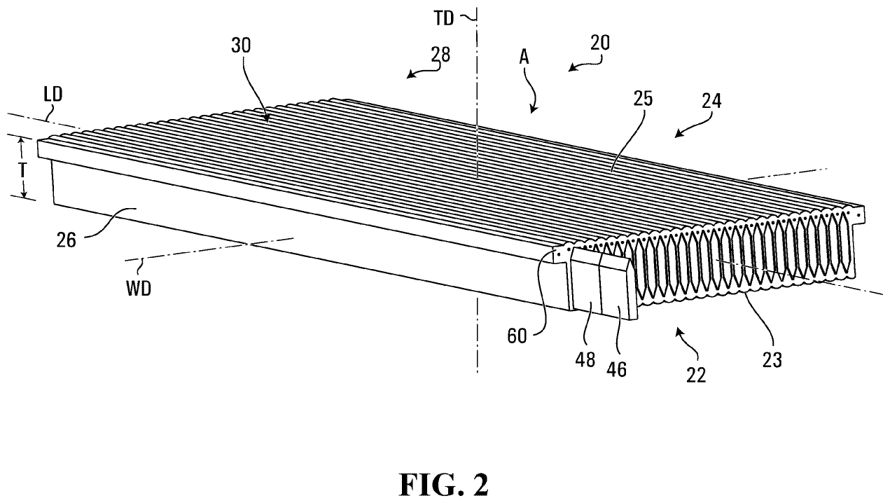

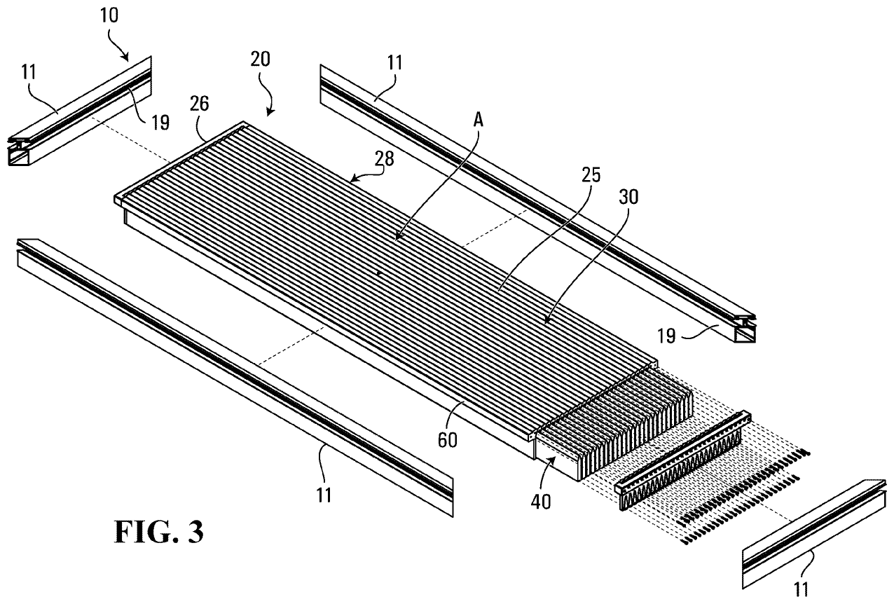

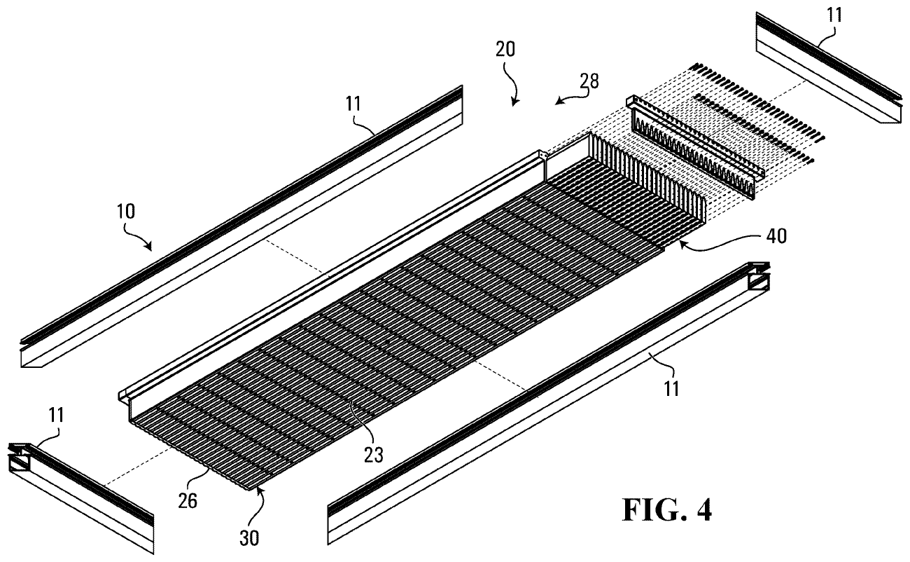

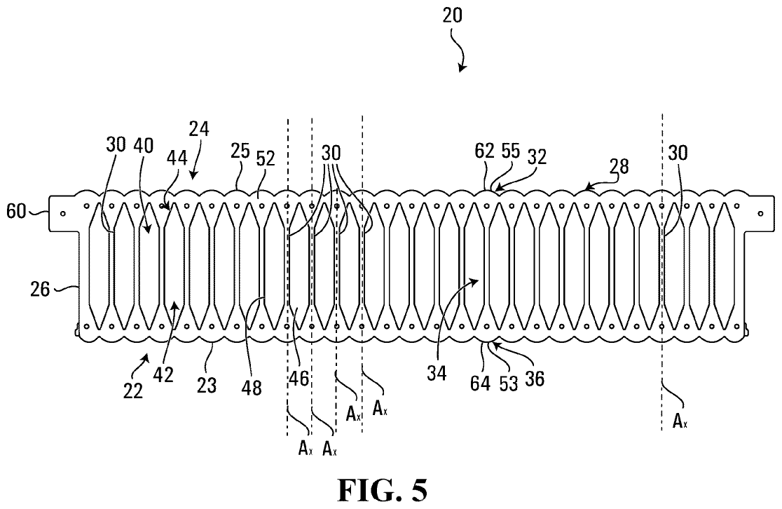

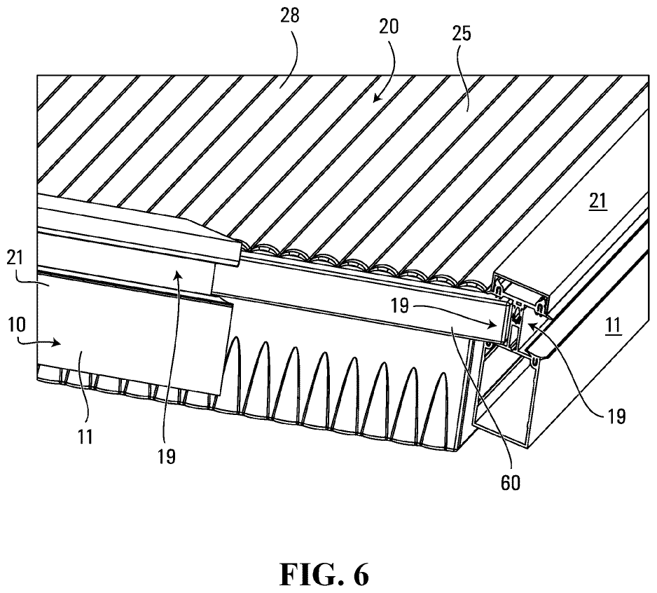

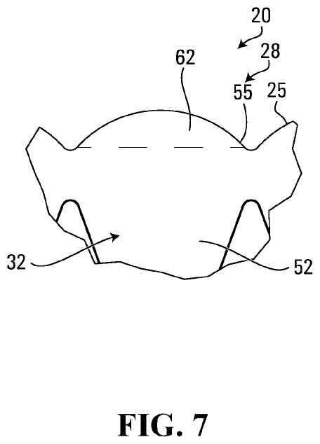

As shown in FIGS. 2 to 6, each panel 20 has an inner side 22 and an outer side 24. Each panel 20 also comprises an inner surface 23 on the inner side 22 and an outer surface 25 on the outer side 24. Each panel 20 may also have a longitudinal direction LD, a widthwise direction WD orthogonal to the longitudinal direction LD, and a thicknesswise TD direction orthogonal to the longitudinal and widthwise directions LD, WD. The panel 20 has an inner surface 22, an outer surface 24 and a perimeter 26. In this embodiment, the perimeter 26 of the panel 20 defines a rectangular shape. In other embodiments, the perimeter 26 of the panel 20 may define any suitable shape, including a square shape, a polygonal shape, a circular shape, etc. The panel may also have any suitable dimensions. For instance, an area A delimited by the perimeter 26 may be at least 400 cm² in some embodiments at least 4000 cm² in some embodiments at least 40000 cm² and in some embodiments even more (e.g., at least 70000cm² ).

In this embodiment, the panel 20 comprises a light-transmitting member 28 comprising light-transmitting devices 30 and a thermal insulator 40 surrounding the light-transmitting devices 30 in the longitudinal and widthwise directions LD, WD of the panel. More specifically, in this embodiment, the panel 20 comprises a plurality of light-transmitting devices 30 disposed adjacent to one another in the longitudinal and widthwise directions LD, WD of the panel 20. For instance, the light pipes 30 may be positioned alongside one-another and organized in a matrix arrangement, i.e., in columns and rows, in a plan that is orthogonal to the thickness direction TD of the panel 20.

In this embodiment, the panel 20 is relatively thin. For instance, in some embodiments, the panel 20 may have a thickness T that is less than 30 cm, in some embodiments less than 20 cm, in some embodiments less than 10 cm, and in some embodiments even less (e.g., 1 cm or less). As another example, in some embodiments, a ratio of the thickness T of the panel 20 over the area A delimited by the perimeter 26 of the panel is less than 0.2cm⁻¹ , in some embodiments less than 0.02cm⁻¹, in some embodiments less than 0.002cm⁻¹, in some embodiments less than 0.0002cm⁻¹, and in some embodiments even less.

In this embodiment, the panel 20 provides a relatively high coefficient of thermal insulation in the thickness direction TD of the panel 20. For instance, in some embodiments, the panel 20 may have a coefficient of thermal insulation of at least R5, in some embodiments of at least R10, in some embodiments of at least R15, in some embodiments of at least R20, and in some embodiments of even more (e.g., of at least R30).

In this embodiment, the panel 20 provides a relatively high light transmittance in the thickness direction TD of the panel 20. For instance, in some embodiments, the panel 20 and the light-transmitting member 28 of the panel 20 may have a light transmittance for light of a desired wavelength range of at least 50%, in some embodiments of at least 60%, in some embodiments of at least 70%, in some embodiments of at least 80%, in some embodiments of at least 90%, and in some embodiments of even more (e.g., of at least 95%).

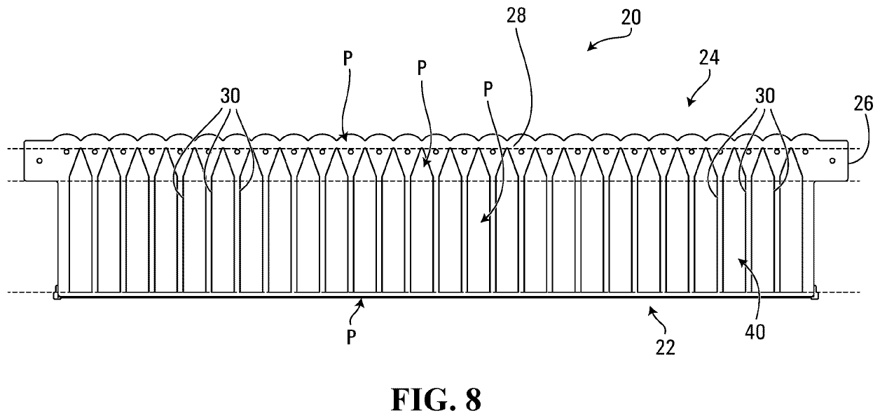

In practical implementation, different suitable approaches may be taken to achieve this. For instance, as shown in FIG. 8, the panel 20 may comprise a plurality of portions P distributed in the thickness direction TD of the panel 20. Each portion P may have a different thickness and R value. For instance, the outermost of the portions P may have a thickness of between 0.5 and 4 cm, and in some embodiments of about 1 cm, and may have a R value of at least 0.3; a second outermost of the portions may have a thickness of between 2 cm and 6 cm, and in some embodiments of about 4.5 cm, and may have a R value of at least 3.3; a third outermost of the portions may have a thickness of between 8 cm and 20 cm, and in some embodiments of about 16 cm, and may have a R value of at least 15; and an innermost of the portions may have a thickness of between 0.1 cm and 1 cm, and in some embodiments of about 0.3 cm, and may have a R value of at least 0.1.

In this embodiment, each light-transmitting device 30 is a light pipe. In this example, each light pipe 30 may be elongate in the thicknesswise direction TD of the panel 20. More specifically, each light pipe 30 may extend along an axis Ax extending in the thicknesswise direction TD of the panel 20 and in some embodiments, a ratio of a length of the light-pipe 30 in the thicknesswise direction TD of the panel 20 over a thickness of the light-pipe 30 in the longitudinal direction LD and/or widthwise direction WD of the panel 20 may be at least 10, in some embodiments at least 50, in some embodiments at least 75 and in some embodiments even more (e.g., at least 100).

The light pipe 30 may comprise a light-receiving portion 32, a light-emitting portion 36 and a transmission portion 34 between the light-receiving portion 32 and the light-emitting portion 36. In this embodiment, the light-receiving portion 32 may be positioned along the outer surface 23 of the panel 20. More specifically, the light-receiving portion 32 may constitute at least part of (i.e., part of, a majority (at least 50%) of, preferably at least 80% of or an entirety of) the outer surface 25 of the panel 20. The light-emitting portion 36 may be positioned along the inner surface 53 of the panel 20. More specifically, the light-emitting portion 23 may constitute at least part of the inner surface 23 of the panel 20. Specifically, in this example, the light-receiving portion 32 of the light pipe 30 may comprise an outer surface 55 that is at least part of the outer surface 25 of the panel 20, and the light-emitting portion 36 of the light pipe 30 may comprise an inner surface 53 that is at least part of the inner surface 23 of the panel 20.

The transmission portion 34 of the light pipe 30 may be narrower than the light-receiving portion 32 and the light-emitting portion 36. This may, for instance, facilitate the use of the thermal insulator 40, increase thermal insulation capabilities of the panel 20, reduce manufacturing costs, reduce weight, etc. For instance, in some embodiments, a ratio of: (i) a cross-section of the transmission portion 34 orthogonal to the thicknesswise direction TD of the panel 20 over (ii) a cross-section of the light-receiving portion 32 orthogonal to the thicknesswise direction TD of the panel 20 and/or a cross-section of the light-emitting portion 36 orthogonal to the thicknesswise direction TD of the panel 20 may be at least 4, in some embodiments at least 9, in some embodiments at least 16, and in some embodiments even more.

In this embodiment, the outer surface 55 may be configured to concentrate light towards the transmission portion 24 of the light pipe 30. To this end, the light-receiving portion 32 of the light pipe 30 may comprise an optical lens 62 configured for concentrate light towards the transmission portion 34 of the light pipe 30. For instance, the outer surface 55 of the light pipe 30 may be uneven, i.e., may be not flat. For example, the outer surface 55 may be convex such as to form the lens 62 to concentrate light towards the transmission portion 24 of the light pipe 30. In this case, the outer surface 55 may be curved to any suitable radius. For instance, in some embodiments, the outer surface 55 may be curved to a radius of less than 30 mm, in some embodiments of less than 15 mm, in some embodiments of less than 10 mm, in some embodiments of less than 5 mm, in some embodiments of less than 1 mm, in some embodiments of less than 0.1 mm, and in some embodiments of even less (e.g., less than 0.01 mm). The uneven shape of the outer surface 55 may increase a surface area of the panel 20. For instance, in this embodiment, a ratio of a surface area defined by the outer surface 25 of the panel 20 over a surface area of the area A defined by the perimeter 26 of the of the panel 20 may be at least 1.05, in some embodiments at least 1.10, in some embodiments at least 1.15, and in some embodiments even more. In other embodiments, however, the outer surface 55 may be even, i.e., flat.

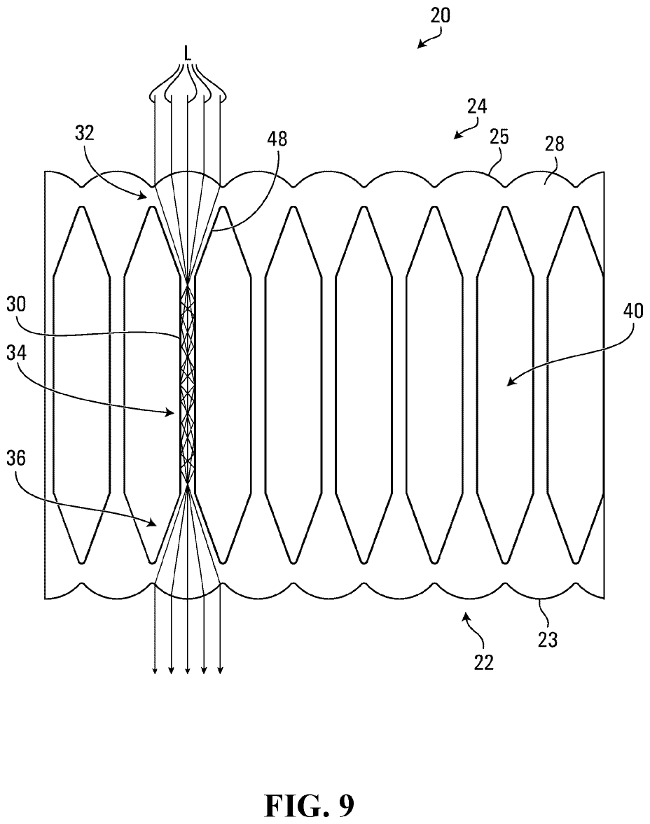

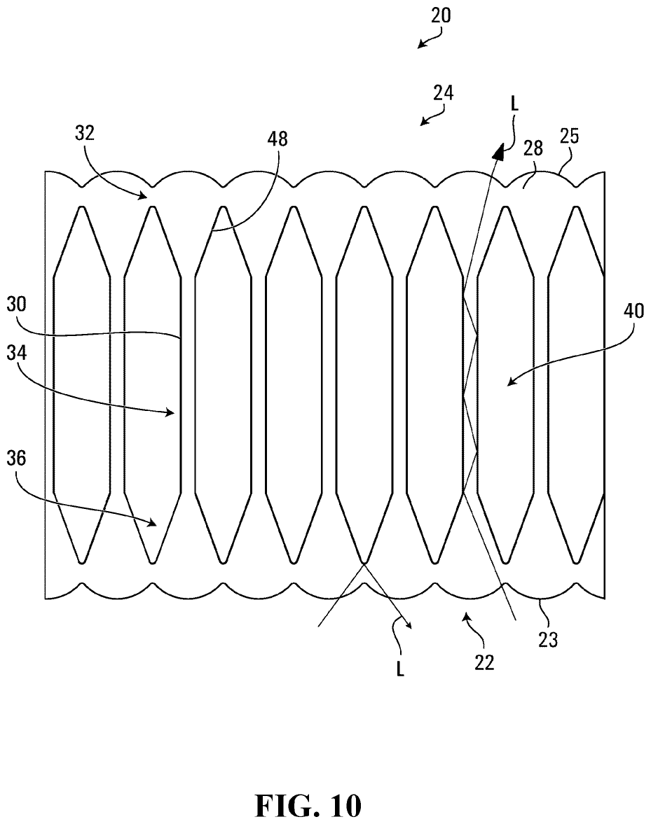

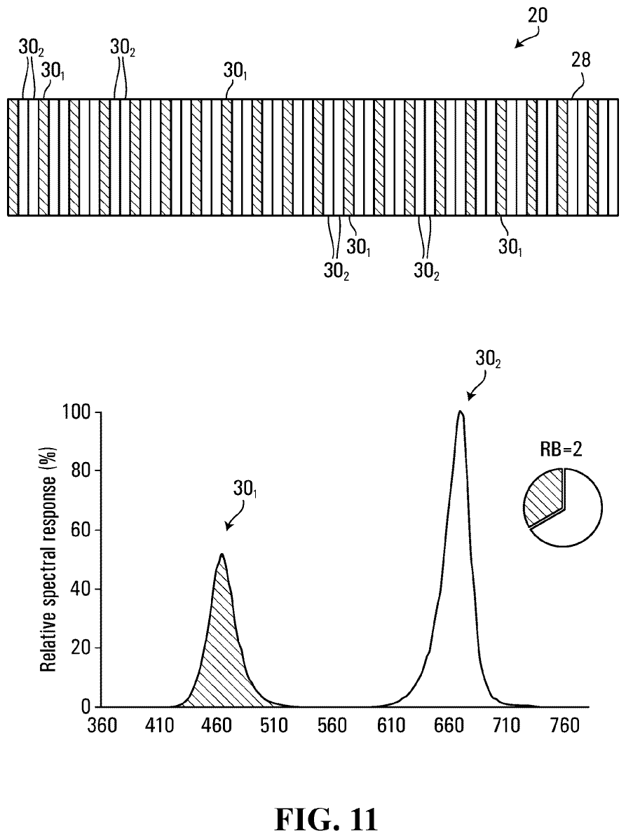

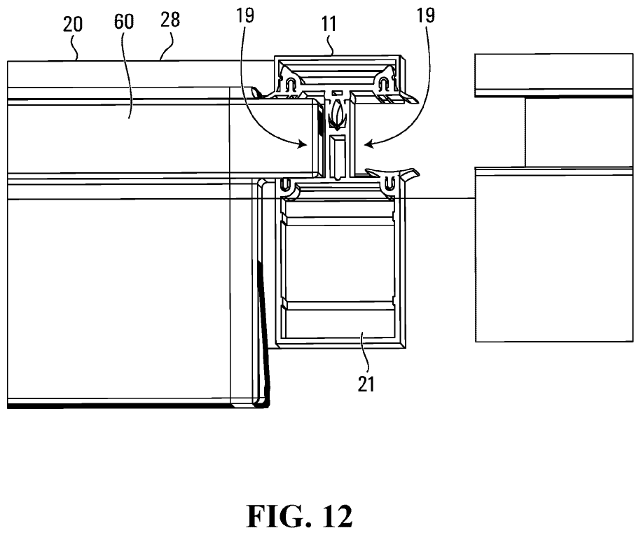

As shown in FIGS. 8 and 9, the transmission portion 34 is configured to transmit light L from the light-receiving portion 32 of the light pipe 30 to the light-emitting portion 36 of the light pipe 30. In this regard, the transmission portion 34 may comprise an optical channel and/or an optical fiber. For instance, outer surfaces of the transmission portion 34 may configured to reflect light L such that every light beam entering the transmission portion 34 from the light-receiving portion 32 bounces back and remains in the transmission portion 34 until the light beam exits the transmission portion 34 towards the light-emitting portion 36 of the light pipe 30, and vice-versa. To achieve this, the transmission portion 34 may be surrounded by a reflector 48 configured to reflect light L.

In a similar fashion, the inner surface 55 may be configured to diffuse light from the transmission portion 24 of the light pipe 30 towards the inner side 22 of the panel 20. To this end, the light-emitting portion 36 of the light pipe 30 may comprise an optical lens 64 configured for diffuse light from the transmission portion 24 of the light pipe 30. For instance, the inner surface 53 of the light pipe 30 may be uneven. For example, the inner surface 53 may be convex such as to form the lens 64 to diffuse light from the transmission portion 24 of the light pipe 30. In this case, the inner surface 53 may be curved to any suitable radius. For instance, in some embodiments, the inner surface 53 may be curved to a radius of less than 15 mm, in some embodiments of less than 10 mm, and in some embodiments of less than 5 mm, in some embodiments of less than 1 mm, in some embodiments of less than 0.1 mm, and in some embodiments of even less (e.g., less than 0.01 mm). The uneven shape of the inner surface 53 may increase a surface area of the panel 20. For instance, in this embodiment, a ratio of a surface area defined by the inner surface 53 of the panel 20 over a surface area of the area A defined by the perimeter 26 of the of the panel 20 may be at least 1.05 , in some embodiments at least 1.10, in some embodiments at least 1.15, and in some embodiments even more. In other embodiments, however, the inner surface 53 may be even.

In this embodiment, the light pipe 30 comprises a translucent material 52. In this embodiment, the material 52 is a polymeric material. The polymeric material 52 may be any suitable translucent polymeric material and may comprise, for instance, polycarbonate, liquid silicone rubber and/or any other translucent polymeric material. In some embodiments, the material 52 may be transparent.

In this embodiment, although the material 52 is translucent to light in a desired range of wavelengths, the material 52 may be configured to interfere with light in a specific range of wavelengths, e.g., to filter the light being transmitted through the panel 20. This may, for instance, improve the environment of the room 18 and facilitate crops'growth. For instance, in this embodiment, the desired range of wavelengths may comprise a photosynthesis area range (PAR) and the material 52 may be configured to interfere with (e.g., absorb, reflect) light of wavelengths outside the PAR, including infrared and thermal infrared wavelengths. In some embodiments, especially in relatively hot environments where the greenhouse 2 is air conditioned during long periods, it may be useful to interfere with thermal infrared wavelengths from the sun 3 to reduce the need for air conditioning. In some embodiments, the PAR is between 360 nm and 850 nm, the desired range of wavelengths is between 360 nm and 850 nm and the material 52 may be configured to interfere with light of wavelengths between 0 nm and 360 nm and/or above 850 nm. In some embodiments, especially in relatively cold environments where the greenhouse 2 is heated during long periods, it may be useful to transmit infrared wavelengths, including thermal infrared wavelengths from the sun 3 to reduce heating needs. As such, in some embodiments, the desired range of wavelengths may comprise the PAR and infrared wavelengths, including thermal infrared wavelengths, and the material 52 may be configured to interfere with (e.g., absorb, reflect) light of wavelengths outside the photosynthesis area range (PAR) and outside the infrared wavelength range. In some embodiments, the infrared wavelength range may be above 800 nm and the material 52 may be configured to interfere with light of wavelengths between 0 nm and 360 nm.

In this embodiment, the material 52 may be configured to interfere with light of specific wavelengths by absorbing and/or reflecting at least a proportion of the light of specific wavelengths the material 52 is interacting with. For instance, in some embodiments, the material 52 may be to absorb and/or reflect at least 40%, in some embodiments at least 50%, in some embodiments at least 60%, in some embodiments at least 70%, in some embodiments at least 80%, in some embodiments at least 90%, and in some embodiments 100% of the light of specific wavelengths the material 52 is interacting with.

In a practical implementation, different suitable approaches may be taken to achieve this. For instance, the material 52 may comprise an additive configured to interfere with the light of preselected wavelengths.

In some embodiments, the material 52 of the light pipes 30 of the panel 20 may be configured to interfere with different wavelength ranges. For instance, the material 52 of a first subset 30i of the light pipes 30 may be configured to interfere with light of in first specific range of wavelengths, and the material 52 of a second subset 302 of the light pipes 30 may be configured to interfere with light in a second specific range of wavelengths different from the first specific range of wavelengths. For example, in some embodiments, the first subset 30i of the light pipes 30 may comprise 25% of the light pipes 30 of the panel 20 and may be configured to interfere with light of wavelengths between 410 nm and 510 nm, and the second subset 302 of the light pipes 30 may comprise 75% of the light pipes 30 of the panel 20 and may be configured to interfere with light of wavelengths between 610 nm and 710 nm. In some embodiments, the light pipes 30 may be configured to either stimulate or inhibit photopigment of crops. For instance, in some embodiments, to increase or reduce a production of A-chlorophyl, the light pipes 30 may be configured to respectively increase or reduce a proportion of 425 nm to 660 nm light in the light transmitted by the panel 20. In this example, increasing a production of chlorophyl A may be achieved, for instance, by having light pipes 30 which are configured to interfere with light of any wavelength except wavelengths between 425 nm and 660 nm. Reducing a production of chlorophyl A may be achieved, for instance, by having light pipes 30 which are configured to interfere with light of wavelength between 425 nm and 660 nm. In a similar fashion, to increase or reduce a production of B-chlorophyl, the light pipes 30 may be configured to respectively increase or reduce a proportion of 460 nm to 640 nm light in the light transmitted by the panel 20 (e.g., by having light pipes 30 which are configured to interfere with light of any wavelength except wavelengths between 460 nm to 640 nm or by having light pipes 30 which are configured to interfere with light of wavelengths between 460 nm to 640 nm, respectively). In a similar fashion, to increase or reduce a production of B-carotene, the light pipes 30 may be configured to respectively increase or reduce a proportion of 450 nm to 500 nm light in the light transmitted by the panel 20 (e.g., by having light pipes 30 which are configured to interfere with light of any wavelength except wavelengths between 450 nm to 500 nm or by having light pipes 30 which are configured to interfere with light of wavelengths between 450 nm to 500 nm, respectively). In a similar fashion, to control a circadian cycle of the crops, the light pipes 30 to control relative proportions of blue light (400 nm to 475 nm) and red light (660 nm to 80 nm) in the light transmitted by the panel 20. For instance, in this example, to stimulate growth of crops, a proportion of blue light may be increased relative to red light (e.g., by having light pipes 30 which are configured to interfere with red light). To stimulate flowering, a proportion of red light may be increased relative to blue light (e.g., by having light pipes 30 which are configured to interfere with blue light).

The light pipes 30 may have any suitable dimension and the panel 20 may comprise any suitable number of light pipes 30. For instance, in some embodiments, the light-transmitting member 28 of the panel 20 may comprise at least 15 light pipes per square centimeter, in some embodiments at least at least 20 light pipes per square centimeter, in some embodiments at least at least 25 light pipes per square centimeter and in some embodiments even more; in some embodiments, the panel 20 may comprise at least 1000 light pipes, in some embodiments at least 10000 light pipes, in some embodiments at least 100000 light pipes, and in some embodiments even more.

In this embodiment, the light pipes 30 are surrounded by the thermal insulator 40. More specifically, the transmission portion 34 of each light pipe 30 may be surrounded by at least a portion of the thermal insulator 40 in the longitudinal and widthwise directions LD, WD of the panel 20. In this embodiment, the thermal insulator 40 of each light pipe 30 partially surrounds the light-receiving portion 32 of the light pipe 30. The thermal insulator 40 may comprise an inner end portion 42 and an outer end portion 44. The inner end portion 42 may engage the light-emitting portions 36 of the light pipes 30 and the outer end portion 44 may engage the light-receiving portions 32 of the light pipes 30.

In this embodiment, the thermal insulator 40 comprises a polymeric material 46. The polymeric material 46 may be any suitable polymeric material 46. For instance, the polymeric material 46 may comprise foam. In some embodiments, the polymeric material 46 may comprise polyurethane, rubber, expended polystyrene and/or silicone aerogel.

In this embodiment, the thermal insulator 40 may be entirely contained within the material 52 of the light pipes 30. In other words, the thermal insulator 40 may be isolated from an exterior of the panel 20. In other embodiments, part of the thermal insulator 40 may be exposed to an exterior of the panel 20.

The thermal insulator 40 may be covered by the reflector 48 configured to reflect light and to guide light rays through the transmission portion 34 to the light-emitting portion 36 of the light pipes. The reflector 48 may comprise any suitable material. For instance, in some embodiments, the reflector 48 may comprise a layer of chrome paint, aluminum, barium sulphate and/or a polymeric film with a reflecting layer.

In this embodiment, the panel 20 comprises a projection 60 defining the perimeter 26 of the panel 20 and configured to facilitate attaching the panel 20 to the frame structure 10. The projection 60 may have any suitable shape. For instance, the projection 60 may have a concave shape, a convex shape, a neutral shape, etc. In this embodiment, the projection has a neutral, rectangular shape.

The projection 60 may be made of any suitable material. In this embodiment, the projection may comprise the material 52 of the light pipes 30.

The panel 20 may be manufactured in any suitable manner. For instance, in this embodiment, the panel 20 may be molded. In particular, in this embodiment, the thermal insulator 40 may be molded in a first molding step. After the first molding step, the thermal insulator 40 may be placed in a mold defining a shape of the panel 20 and the light pipes 30 and the perimeter 60 may be molded (e.g., by injection molding) over the thermal insulator 40. In this regard, the light pipes 30 and the thermal insulator 40 may be molded over one another.

In some embodiments, the light pipes 30 may be molded first and a precursor of the polymeric material 46 of the thermal insulator 40 may be injected into cavities of the body forming the light pipes 30. The panel 20 may be cured, creating an expansion of the precursor of the polymeric material 46 of the thermal insulator 40, forming the polymeric material 46 and the thermal insulator 40.

In other embodiments, the light pipes 30 and/or the thermal insulator 40 may be extruded. For instance, in some embodiments, the body of the light pipes 30 may be molded and the thermal insulator 40 may be molded or extruded separately. The thermal insulator 40 may be covered by the reflector 48 and then inserted into the body of the light pipes 30.

In some embodiments, also, the light pipes 30 and the thermal insulator 40 may be affixed to one another in any suitable way. For instance, the panel 20 may comprise fasteners (e.g., mechanical fasteners, screws, staples, etc.), adhesive (e.g., glue) affixing the light pipes 30 the thermal insulator 40 to one another. Alternatively or additionally, the light pipes 30 and the thermal insulator 40 may be mechanically interlocked.

The frame structure 10 comprises frame members 11 and is configured to form a panel assembly to attach the panels 20 to the greenhouse 2. In this embodiment, each panel 20 may be connected to and engage frame members 11 of the frame structure 10 along their respective peripheries 26 to constitute at least part of the walls 12 and/or roof sections 14 of the greenhouse 2.

In this embodiment, the frame members 11 are longitudinal. In particular, in this embodiment, each frame member 11 may comprise one or more recess 19 configured to engage the projection 60 of the panel 20 to hold the panel 20 into place. Each frame member 11 may thus be configured to engage at least one side of a panel 20. More specifically, in this embodiment, the frame member 11 has a symmetrical shape and comprises two opposed recesses such that the frame member can hold a side of two adjacent panels 20 and therefore connect these adjacent panels 20 to one another.

In this embodiment, the panels 20 are slidably engaged into the recesses 19 of the frame members 11. In other embodiments, the panels 20 may be connected, attached and/or affixed to the frame members 11 in any suitable fashion, including by tight fit, by mechanical interlock, by a mechanical fastener (e.g., a screw, a nail, etc.), by an adhesive (e.g., glue), etc. For instance, in some embodiments, the panels 20 may be permanently affixed to the frame member 11.

The frame member 11 comprises a material 21. In this embodiment, the material 21 is a metallic material. For instance, the material 21 may be aluminum, an aluminum alloy, steel, etc. In some embodiments, the material 21 may comprise a polymeric material. For instance, the material 21 may comprise a polyurethane.

In practical implementation, different suitable approaches may be taken to manufacture the frame member 11. For instance, the frame member 11 may be molded, extruded, bent into shape, etc.

The panel 20 and/or the frame structure 10 may be implemented in various other ways in other embodiments.

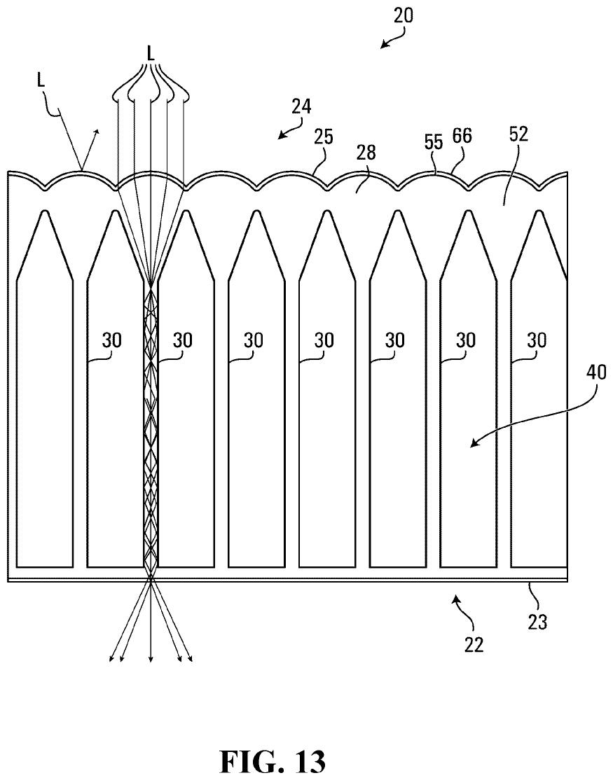

For example, in some embodiments, as shown in FIG. 13, the panel 20 may comprise an outer filter 66 positioned between the outer surface of the panel and the light-transmitting member disposed outwards relative to the light pipes 30 and configured to interfere with light in a specific range of wavelengths. More specifically, in this embodiment, the outer filter 66 may be applied over the outer surface 55 of the light pipes 30. The outer filter 66 may be configured reflect and/or absorb at least part of the light in a specific range of wavelengths and be translucent to a desired range of wavelengths. For instance, in this embodiment, the desired range of wavelengths may comprise the PAR and the outer filter 66 may be configured to interfere with (e.g., absorb, reflect) light of wavelengths outside the PAR, including infrared and thermal infrared wavelengths. In some embodiments, especially in relatively hot environments where the greenhouse 2 is air conditioned during long periods, it may be useful to interfere with thermal infrared wavelengths from the sun 3 to reduce the need for air conditioning. In some embodiments, the PAR is between 360 nm and 850 nm, the desired range of wavelengths is between 360 nm and 850 nm and the outer filter 66 may be configured to interfere with light of wavelengths between 0 nm and 360 nm and/or above 850 nm. In some embodiments, especially in relatively cold environments where the greenhouse 2 is heated during long periods, it may be useful to transmit infrared wavelengths, including thermal infrared wavelengths from the sun 3 to reduce heating needs. As such, in some embodiments, the desired range of wavelengths may comprise the PAR and infrared wavelengths, including thermal infrared wavelengths, and the outer filter 66 may be configured to interfere with (e.g., absorb, reflect) light of wavelengths outside the photosynthesis area range (PAR) and outside the infrared wavelength range. In some embodiments, the infrared wavelength range may be above 800 nm and the outer filter 66 may be configured to interfere with light of wavelengths between 0 nm and 360 nm.

In some embodiments outer filter 66 may be configured to interfere with light of wavelengths between 410 nm and 510 nm and/or between 610 nm and 710 nm. In some embodiments, to increase or reduce a production of A-chlorophyl, the outer filter 66 may be configured to respectively increase or reduce a proportion of 425 nm to 660 nm light in the light transmitted by the panel 20. In this example, increasing a production of chlorophyl A may be achieved, for instance, by the outer filter 66 interfering with light of any wavelength except wavelengths between 425 nm and 660 nm. Reducing a production of chlorophyl A may be achieved, for instance, by the outer filter 66 interfering with light of wavelength between 425 nm and 660 nm. In a similar fashion, to increase or reduce a production of B-chlorophyl, the outer filter 66 may be configured to respectively increase or reduce a proportion of 460 nm to 640 nm light in the light transmitted by the panel 20 (e.g., by interfering with light of any wavelength except wavelengths between 460 nm to 640 nm or by interfering with light of wavelengths between 460 nm to 640 nm, respectively). In a similar fashion, to increase or reduce a production of B-carotene, the outer filter 66 may be configured to respectively increase or reduce a proportion of 450 nm to 500 nm light in the light transmitted by the panel 20 (e.g., by interfering with light of any wavelength except wavelengths between 450 nm to 500 nm or by interfering with light of wavelengths between 450 nm to 500 nm, respectively). In a similar fashion, to control a circadian cycle of the crops, the outer filter 66 may control relative proportions of blue light (400 nm to 475 nm) and red light (660 nm to 80 nm) in the light transmitted by the panel 20. For instance, in this example, to stimulate growth of crops, a proportion of blue light may be increased relative to red light (e.g., by the outer filter 66 interfering with red light). To stimulate flowering, a proportion of red light may be increased relative to blue light (e.g., by the outer filter 66 interfering with blue light).

In this embodiment, the outer filter 66 may be configured to interfere with light of specific wavelengths by absorbing and/or reflecting at least a proportion of the light of specific wavelengths the outer filter 66 is interacting with. For instance, in some embodiments, the outer filter 66 may be to absorb and/or reflect at least 40%, in some embodiments at least 50%, in some embodiments at least 60%, in some embodiments at least 70%, in some embodiments at least 80%, in some embodiments at least 90%, and in some embodiments 100% of the light of specific wavelengths the outer filter 66 is interacting with.

The outer filter 66 may comprise any suitable material. For instance, in some embodiments, the outer filter 66 may comprise a layer and/or a film of VUV enhanced aluminum, DEV enhanced aluminum, UV enhanced aluminum, protected aluminum, enhanced aluminum, protected silver, ultrafast enhanced silver, protected gold and/or bare gold. The layer and/or film of the outer filter 66 may comprise a reflective layer. The outer filter 66 may be relatively thin. For instance, in some embodiments, the outer filter 66 may have a thickness less than 20 000 nm, in some embodiments less than 10 000 nm, in some embodiments less than 1 000 nm, in some embodiments less than 500 nm, in some embodiments less than 250 nm and in some embodiments even less.

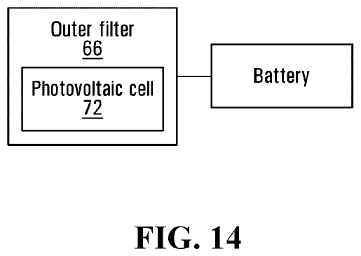

In some embodiments, as shown in FIG. 14, the outer filter 66 may comprise a photovoltaic cell 72 configured to capture energy of at least part of the light in a specific range of wavelengths. In this regard, the photovoltaic cell 72 may be connected directly or indirectly (e.g., in series with other photovoltaic cell) to a battery to store the energy captured by the photovoltaic cell 72. In this example, the photovoltaic cell 72 may be translucent to light of wavelengths different from the predetermined wavelengths of the outer filter 66. For instance, the photovoltaic cell 72 may comprise a photovoltaic membrane.

In some embodiments, the photovoltaic cell 72 may also be applied on the reflector 48 in order to capture energy from light entering the light-transmitting member 28. In this example, a surface area of the photovoltaic cell 72 may be significantly greater than the surface area defined by the outer surface 25 of the panel 20. In some embodiments, a ratio of the surface area of the photovoltaic cell 72 over the surface area defined by the outer surface 25 of the panel 20 may be at least 1.5, in some embodiments at least 3, in some embodiments at least 4.5, and in some embodiments even more (e.g., at least 5).

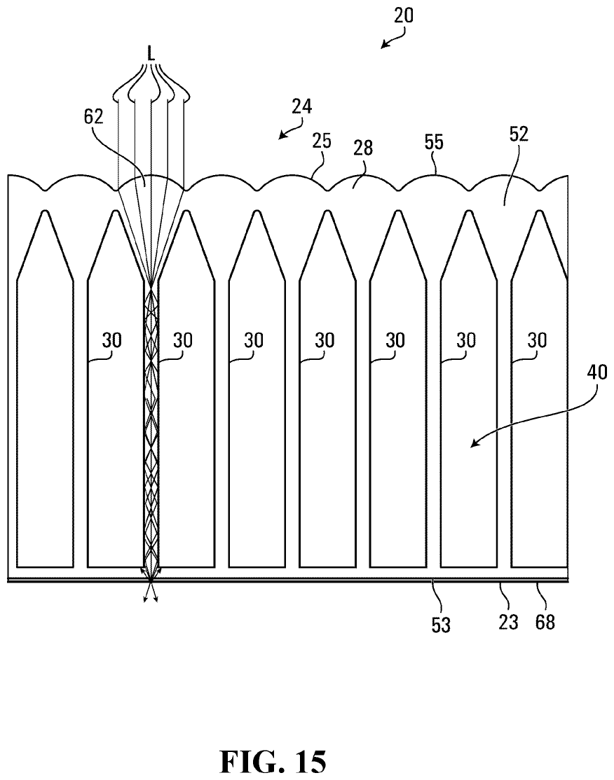

As another example, in some embodiments, as shown in FIG. 15, the panel 20 may comprise an inner filter 68 disposed inwards relative to the light pipes 30 and configured to interfere with light in a specific range of wavelengths. More specifically, in this embodiment, the inner filter 68 may be applied over the inner surface 53 of the light pipes 30. The inner filter 68 may be configured reflect and/or absorb at least part of the light in a specific range of wavelengths. For instance, in some embodiments inner filter 68 may be configured to interfere with light of wavelengths between 410 nm and 510 nm and/or between 610 nm and 710 nm. For instance, in this embodiment, the desired range of wavelengths may comprise the PAR and the inner filter 68 may be configured to interfere with (e.g., absorb, reflect) light of wavelengths outside the PAR, including infrared and thermal infrared wavelengths. In some embodiments, especially in relatively hot environments where the greenhouse 2 is air conditioned during long periods, it may be useful to interfere with thermal infrared wavelengths from the sun 3 to reduce the need for air conditioning. In some embodiments, the PAR is between 360 nm and 850 nm, the desired range of wavelengths is between 360 nm and 850 nm and the inner filter 68 may be configured to interfere with light of wavelengths between 0 nm and 360 nm and/or above 850 nm. In some embodiments, especially in relatively cold environments where the greenhouse 2 is heated during long periods, it may be useful to transmit infrared wavelengths, including thermal infrared wavelengths from the sun 3 to reduce heating needs. As such, in some embodiments, the desired range of wavelengths may comprise the PAR and infrared wavelengths, including thermal infrared wavelengths, and the inner filter 68 may be configured to interfere with (e.g., absorb, reflect) light of wavelengths outside the photosynthesis area range (PAR) and outside the infrared wavelength range. In some embodiments, the infrared wavelength range may be above 800 nm and the inner filter 68 may be configured to interfere with light of wavelengths between 0 nm and 360 nm.

In some embodiments, to increase or reduce a production of A-chlorophyl, the inner filter 68 may be configured to respectively increase or reduce a proportion of 425 nm to 660 nm light in the light transmitted by the panel 20. In this example, increasing a production of chlorophyl A may be achieved, for instance, by the inner filter 68 interfering with light of any wavelength except wavelengths between 425 nm and 660 nm. Reducing a production of chlorophyl A may be achieved, for instance, by the inner filter 68 interfering with light of wavelength between 425 nm and 660 nm. In a similar fashion, to increase or reduce a production of B-chlorophyl, the inner filter 68 may be configured to respectively increase or reduce a proportion of 460 nm to 640 nm light in the light transmitted by the panel 20 (e.g., by interfering with light of any wavelength except wavelengths between 460 nm to 640 nm or by interfering with light of wavelengths between 460 nm to 640 nm, respectively). In a similar fashion, to increase or reduce a production of B-carotene, the inner filter 68 may be configured to respectively increase or reduce a proportion of 450 nm to 500 nm light in the light transmitted by the panel 20 (e.g., by interfering with light of any wavelength except wavelengths between 450 nm to 500 nm or by interfering with light of wavelengths between 450 nm to 500 nm, respectively). In a similar fashion, to control a circadian cycle of the crops, the inner filter 68 may control relative proportions of blue light (400 nm to 475 nm) and red light (660 nm to 80 nm) in the light transmitted by the panel 20. For instance, in this example, to stimulate growth of crops, a proportion of blue light may be increased relative to red light (e.g., by the inner filter 68 interfering with red light). To stimulate flowering, a proportion of red light may be increased relative to blue light (e.g., by the inner filter 68 interfering with blue light).

The inner filter 68 may comprise any suitable material. For instance, in some embodiments, the inner filter 68 may comprise a layer and/or a film of VUV enhanced aluminum, DEV enhanced aluminum, UV enhanced aluminum, protected aluminum, enhanced aluminum, protected silver, ultrafast enhanced silver, protected gold and/or bare gold. The layer and/or film of the inner filter 68 may comprise a reflective layer. The inner filter 68 may be relatively thin. For instance, in some embodiments, the inner filter 68 may have a thickness less than 20 000 nm, in some embodiments less than 10 000 nm, in some embodiments less than 1 000 nm, in some embodiments less than 500 nm, in some embodiments less than 250 nm and in some embodiments even less.

In this embodiment, the inner filter 68 may be configured to interfere with light of specific wavelengths by absorbing and/or reflecting at least a proportion of the light of specific wavelengths the inner filter 68 is interacting with. For instance, in some embodiments, the inner filter 68 may be to absorb and/or reflect at least 40%, in some embodiments at least 50%, in some embodiments at least 60%, in some embodiments at least 70%, in some embodiments at least 80%, in some embodiments at least 90%, and in some embodiments 100% of the light of specific wavelengths the inner filter 68 is interacting with.

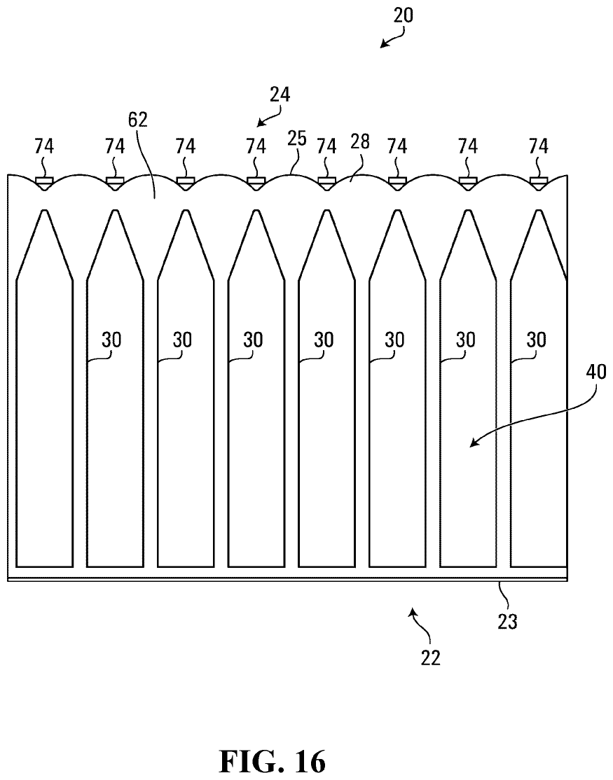

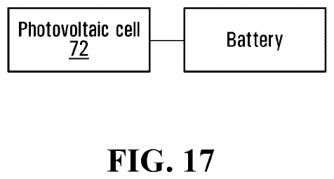

As another example, in some embodiments, as shown in FIGS. 16 and 17 the panel 20 may comprise a photovoltaic cell 74 which may be opaque or translucent and which may be disposed outwards to light pipes 30 and offset relative to the transmission portions 34 of the light pipes 30. More specifically, the photovoltaic cell 74 may cover In this configuration, the photovoltaic cell 74 may cover areas of the panel 20 where a lesser proportion of light is directed towards the transmission portions 34. In this example, the photovoltaic cell 74 may be connected directly or indirectly (e.g., in series with other photovoltaic cell) to a battery to store the energy captured by the photovoltaic cell 74.

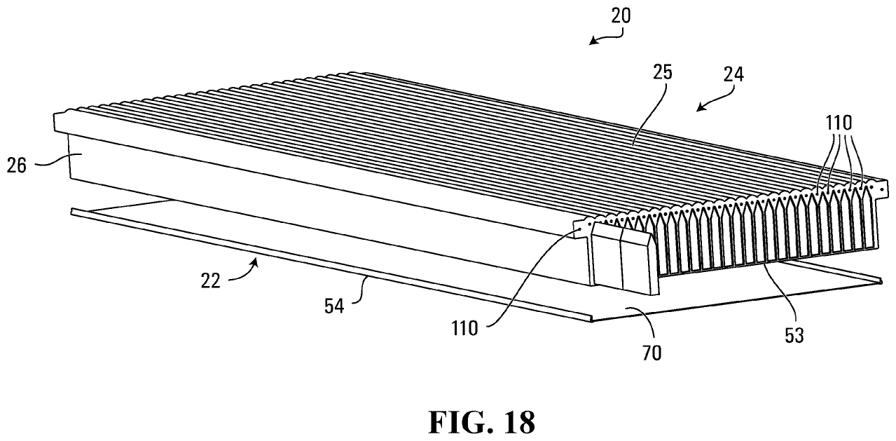

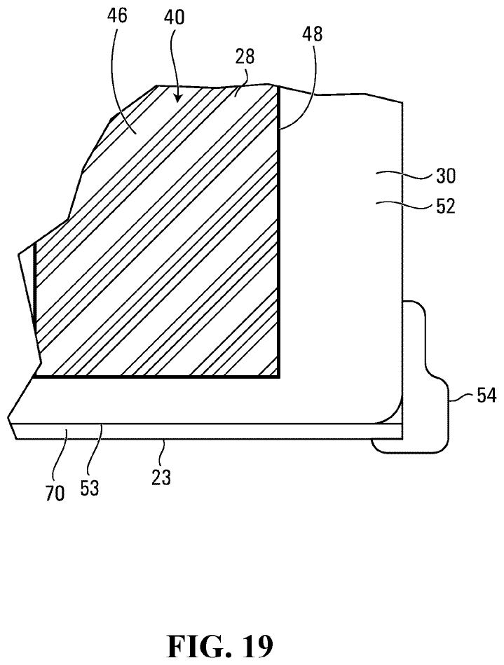

As another example, in some embodiments, as shown in FIGS. 18 and 19, the panel 20 may comprise a screen 70 located on the inner side 22 of the panel 20 to modulate an opacity of the panel 20 and diffuse the light emitted by the light-emitting portion 36 of the light pipes 30. The screen 70 may extend over a significant portion of the inner surface 53. For instance, in some embodiments, the screen 70 may extend over at least 50% of the light-transmitting member 28 of the panel 20, in some embodiments over at least 80% of the light-transmitting member 28 of the panel 20, and in some embodiments over an entirety (i.e., 100%) of the light-transmitting member 28 of the panel 20.

The screen 70 may be disposed over the inner surface 53 of the light pipes 30 and may define at least part of the inner surface 23 of the panel 20. In this embodiment, the panel 20 may comprise supports 54 affixed to the perimeter 26 of the panel 20 and configured to attach the screen 70 to the panel 20. For example, the supports 54 may be affixed to the light pipes 30 and/or to the thermal insulator 40 of the panel 20 and/or to any other suitable component of the panel 20 to secure the screen 70.

In this embodiment, the screen 70 may be a liquid crystal display (LCD) screen. In this embodiment, the opacity of the LCD screen 70 may be adjustable manually (i.e., via user input). For instance, the panel 20 may comprise an actuator 78 operable by a user to adjust the opacity of the LCD screen 70. In some embodiments, the opacity of the LCD screen 70 may be adjustable automatically in addition or in replacement to being adjustable manually. For instance, in some embodiments, the LCD screen 70 may be responsive to control signals received for adapting operating parameters associated with the LCD screen 70 to affect the lighting characteristics of the greenhouse 2 based on said control signals. In this example, the LCD screen 70 may be responsive to control signals received for adapting the opacity of the LCD screen 70.

The control signals may be generated by any suitable device. For instance, in some embodiments, the greenhouse 2 comprises an electronic actuator configured to generate and convey said control signals to the LCD screen 70. In some embodiments, the greenhouse 2 may comprise a processing apparatus comprising an interface, a memory portion and a processing portion. The interface may comprise a user interface configured to convey information to a user and/or to receive user input. For instance, said interface may comprise a display, buttons, and so on. In response to user input and/or in response to an algorithm being processed by the processing portion, the interface may convey said control signals to the LCD screen 70 for adapting the opacity of the LCD screen 70.

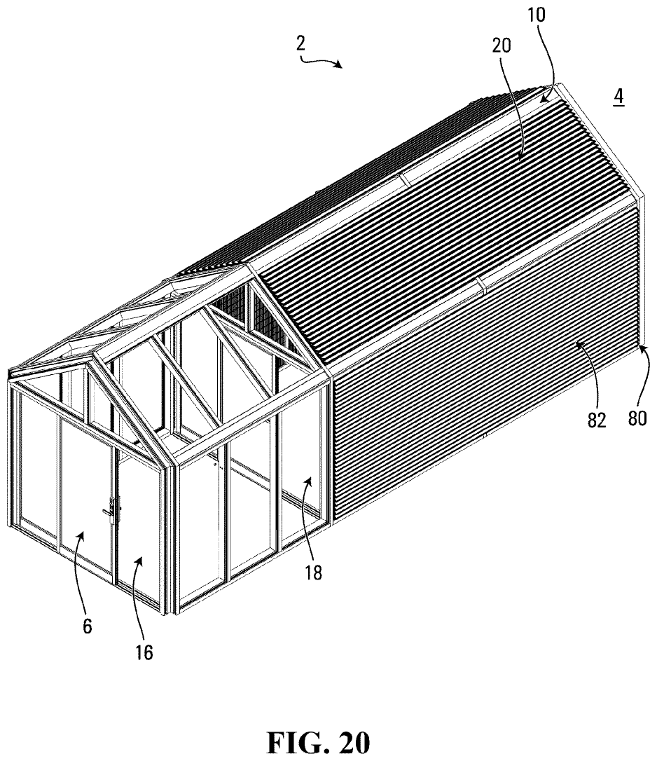

As another example, in some embodiments, as shown in FIG. 20, the greenhouse 2 may comprise shutters 80 disposed over the outer surface 25 of the panels 20 and extending along the light-transmitting members 21 of the panels 20. The shutters may be disposed over the panels 20 to control an exposure to light of the panels 20 by adjusting a shutter-opening setting. That is, the shutters 80 may be configured for moving between a closed position and an open position to modulate an opacity of the panels and to affect the lighting characteristics of the greenhouse 2 and, as such, may be adjustable. The shutter-opening setting of the shutters 80 may be adjustable manually (i.e., via user input) and/or automatically. For instance, in some embodiments, the shutters 80 may comprise an actuator 82 for adjusting the opening setting of the shutters 80. In this example, the actuator 82 may comprise an electromagnetic actuator.

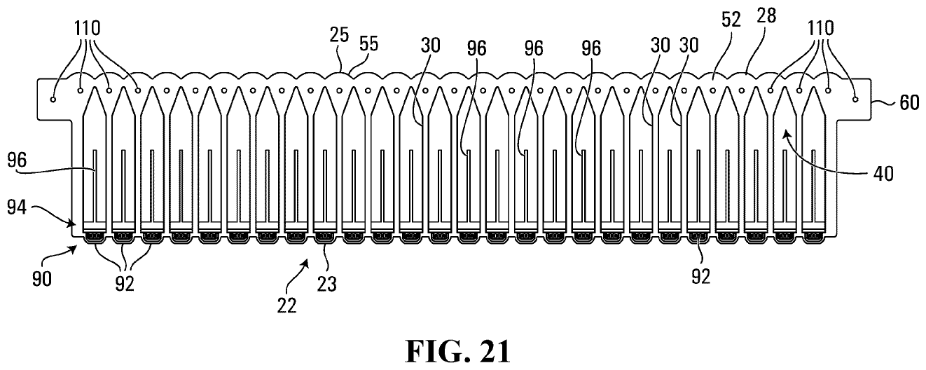

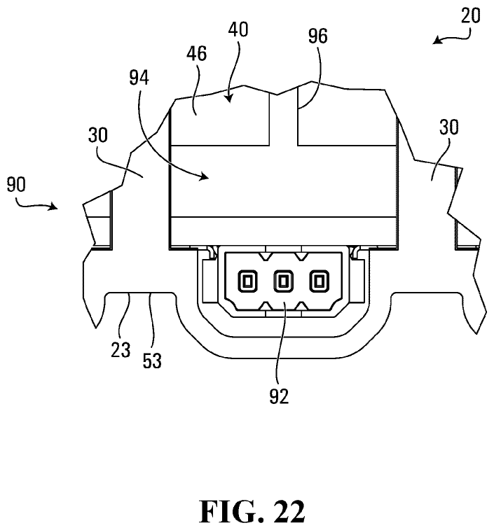

As another example, in some embodiments, as shown in FIG. 21 to 23, the panel 20 may comprise a lighting system 90 (also referred-to as light system) configured to complement light emission of the light-emitting portions 36 of the light pipes 30. In this embodiment, the light system 90 comprises a plurality of light emitting diode (LED) 92 located on the inner side 22 of the panel 20 and an actuator 94 for turning on and off the LEDs 92 and optionally adjusting a brightness of the LEDs 92. More specifically, the LEDs 92 may be disposed over the inner surface 23 of the panel 20, inwards the inner surface 53 of the light-emitting portion 36 of the light pipes 30.

The LEDs 92 may be configured to emit light in a specific range of wavelengths. For instance, in some embodiments, the LED 92 may be configured to emit light of a wavelength between 280 nm and 2000 nm. In some embodiments, different LEDs 92 may be configured to emit light of different wavelengths. For instance, a first subset of the LEDs (e.g., 25% of the LEDs) may be configured to generate light of 475 nm; a second subset of the LEDs (e.g., 25% of the LEDs) may be configured to generate light of 660 nm; a third subset of the LEDs (e.g., 25% of the LEDs) may be configured to generate light of 780 nm; and a fourth subset of the LEDs (e.g., 25% of the LEDs) may be configured to generate light of 580 nm. The LEDs 92 and/or each subset of the LEDs 92 may be turned on and/or shut down manually (i.e., via user input) and/or automatically, and a brightness of the LEDs 92 and/or each subset of the LEDs 92 may be adjustable manually and/or automatically.

For instance, in some embodiments, the LEDs 92 may be responsive to control signals received for adapting operating parameters associated with the LEDs 92 to affect the lighting characteristics of the greenhouse 2 based on said control signals. In this example, the LEDs 92 may be responsive to control signals received for adapting the brightness level of the LEDs 92.

The control signals may be generated by any suitable device. For instance, in some embodiments, the greenhouse 2 comprises an electronic actuator configured to generate and convey said control signals to the LEDs 92. In some embodiments, the greenhouse 2 may comprise a processing apparatus comprising an interface, a memory portion and a processing portion. The interface may comprise a user interface configured to convey information to a user and/or to receive user input. For instance, said interface may comprise a display, buttons, and so on. In response to user input and/or in response to an algorithm being processed by the processing portion, the interface may convey said control signals to the LEDs 92 for adapting the brightness level of the LEDs 92.

In some embodiments, the lighting system 90 may be used to control a circadian cycle of the crops. For instance, the operating parameters associated with the LEDs 92 may be monitored over time to control relative proportions of ambient blue light (400 nm to 475 nm) and ambient red light (660 nm to 80 nm) inside the greenhouse 2. For instance, in this example, to stimulate growth of crops during a specific period of time, a proportion of ambient blue light may be increased relative to ambient red light (e.g., by increasing a brightness level of LEDs emitting blue light and/or by reducing a brightness level of LEDs emitting any non-blue light), and to stimulate flowering during a specific period of time, a proportion of red light may be increased relative to blue light (e.g., by increasing a brightness level of LEDs emitting red light and/or by reducing a brightness level of LEDs emitting any non-red light).

The LEDs 92 may be any suitable type of LED. For example, the LEDs 92 may comprise a printed circuit on an aluminum base.

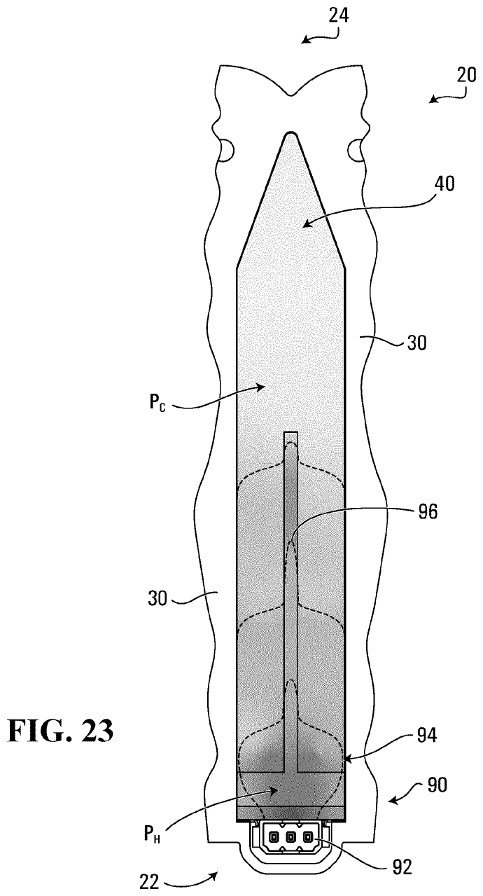

In this embodiment, the panel 20 may also comprise a heat dissipator 94 connected to the LEDs 92 and configured to dissipate heat generated by the LEDs 92 and/or by the interior of the greenhouse 2. The heat dissipator 94 may comprise fins 96 extending into the panel 20 towards the outer side 24 of the panel 20. In this example, the fins 96 extend into the thermal insulator 40 of the panel 20. More specifically, each fin 96 may extend into the thermal insulator 40 at mid-distance between adjacent light pipes 30. As shown in FIG. 23, the fin 96 may distribute heat such that portions of the panels 20 are hotter than others. For instance, a portion PH of the panel 20 closer to the inner surface 23 of the panel 20 may be hotter than a portion Pc of the panel 20 closer to the outer surface 25 of the panel.

The fins 96 may be made of any suitable material. In this embodiment, the fins 96 are heat conductive. More specifically, in this embodiment, the fins comprise aluminum or an aluminum alloy.

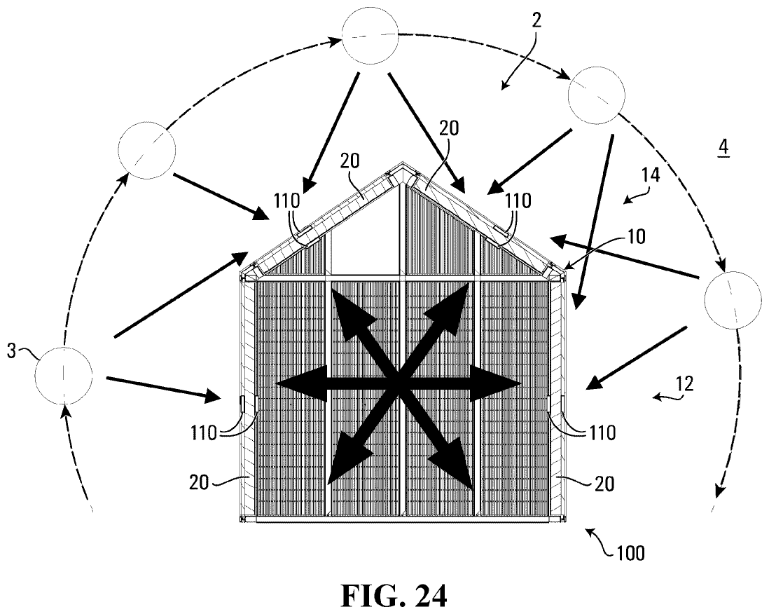

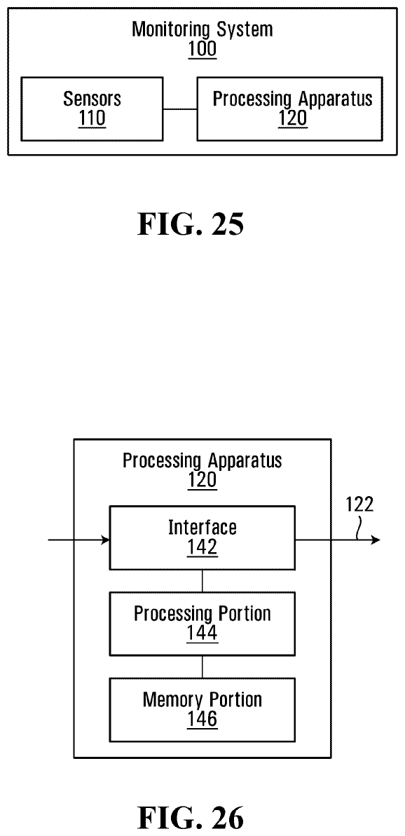

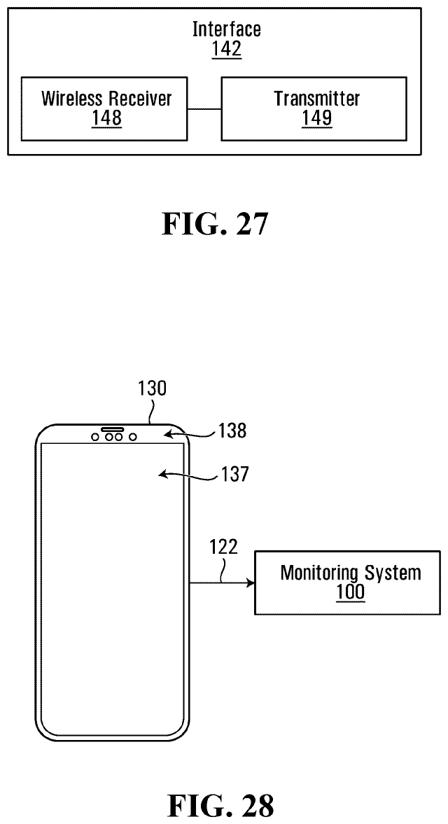

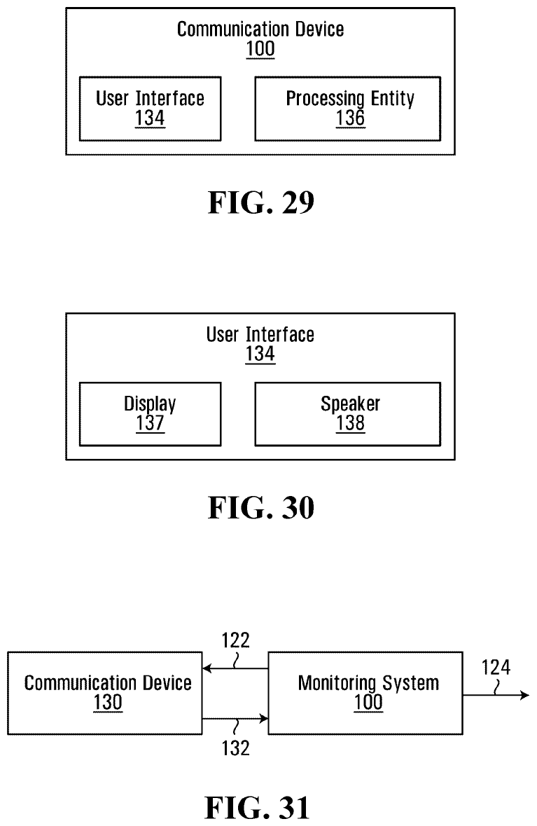

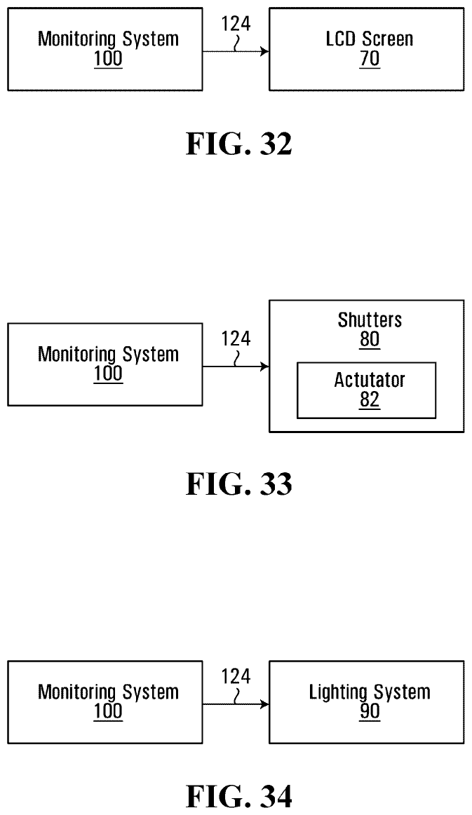

As another example, in some embodiments, as shown in FIGS. 24 to 34, the panels 20 may comprise a monitoring system 100 for monitoring the panels 20 to obtain information about an environment of the panels which can be used for various purposes, such as, for example, to monitor a position and/or a brightness of the sun 3, to monitor a light intensity transmitted by the panel 20, to monitor air humidity of an environment, to monitor a temperature of an environment, to facilitate growing crops, etc. In particular, in this embodiment, the monitoring system 100 is configured to sense one or more characteristics an environment of the panels 20.

In this embodiment, at least some of the panels 20 may comprise a plurality of sensors 110 configured to sense and measure a characteristic of an environment of the panels 20 and generate a signal conveying a measurement of the characteristic for transmittal to the monitoring system 100. The monitoring system 100 may be in communication with the sensors 110. For instance, the monitoring system 100 may comprise a processing apparatus 120 in communication with the sensors 110, configured for receiving the signal conveying the measurement of the characteristic, and further configured for processing the signal and rendering a user interface on a display device 130 in communication with the monitoring system 100, the user interface presenting information derived by processing the measurement of the characteristic. More specifically, the processing apparatus 120 may be configured to process the signal conveying the measurement of the characteristic and generate a signal 122 relating to the characteristic of the environment of the panels 20 and/or to whether acceptable conditions for growing crops in the greenhouse 2 are met, and the signal 122 may convey information derived by processing the characteristic to the display device 130 comprising a user interface 134.

The environment of the panels 20 may comprise an inner environment on the inner side 22 of the panels 20 and/or an outer environment on the outer side 24 of the panels 20. Accordingly, the sensors 110 may be disposed on or proximate to the inner surface 23 and/or on or proximate to the outer surface 25 of the panels 20.

The sensors 110 used in practical implementations may include various suitable types of sensors. For instance, the sensors 110 may comprise a luminosity sensor configured to sense luminosity, a temperature sensor configured to sense temperature, and/or a humidity sensor configured to sense air humidity.

In this embodiment, the sensors 110 may be weatherproof. For instance, each sensor 110 may comprise a sensing device 112 configured to sense the characteristic of the environment and may be housed in a housing 114 that protects the sensing device 112. In particular, in this embodiment, the panels 20 may comprise recesses constituting at least part of the housings 114 of the sensors 110. In this embodiment, each sensor 110 may be fastenable to a respective housing 114 to attach the sensor 110 to and detach the sensor 110 from the housing 114.

In this embodiment, the processing apparatus 120 comprises an interface 142, a processing portion 144, and a memory portion 146, which are implemented by suitable hardware and/or software.

The interface 142 comprises one or more inputs and outputs allowing the processing apparatus 120 to receive input signals from and send output signals to other components to which the processing apparatus 120 is connected (i.e., directly or indirectly connected), including, in this embodiment, the sensor 110. For example, in this embodiment, an input of the interface 142 is implemented by a wireless receiver 148 to receive a sensor signal from the sensor 110. An output of the interface 142 is implemented by a transmitter 149 to transmit the signal 122.

The processing portion 144 comprises one or more processors for performing processing operations that implement functionality of the processing apparatus 120. A processor of the processing portion 144 may be a general-purpose processor executing program code stored in the memory portion 146. Alternatively, a processor of the processing portion 144 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 146 comprises one or more memories for storing program code executed by the processing portion 144 and/or data used during operation of the processing portion 144. The memory portion 146 could also be used for storing data (e.g., temperature readings, reference temperatures). A memory of the memory portion 146 may be a semiconductor medium (including, e.g., a solid-state memory), a magnetic storage medium, an optical storage medium, and/or any other suitable type of memory. A memory of the memory portion 146 may be read-only memory (ROM) and/or random-access memory (RAM), for example.

In some embodiments, two or more elements of the processing apparatus 120 may be implemented by devices that are physically distinct from one another and may be connected to one another via a bus (e.g., one or more electrical conductors or any other suitable bus) or via a communication link which may be wired, wireless (e.g., using a Bluetooth protocol, over a Wifi network, over a 5G network, etc.), or both. In other embodiments, two or more elements of the processing apparatus 120 may be implemented by a single integrated device. In some embodiments, at least part of the processing apparatus 120 in integrated into a remote device such as a smartphone or a remote computer. For instance, in some embodiments, part of the processing apparatus 120 may be integrated into a cloud.

In this embodiment, the interface 142 may be configured to receive a signal indicative of a characteristic of the greenhouse 2 and/or of a panel 20 (e.g., luminosity, temperature, humidity, etc.) and may be configured to assess whether acceptable conditions for growing crops are met, and generate the signal 122 relating to conditions for growing crops based on the characteristic of the greenhouse 2 and/or of a panel 20. Specifically, in this example, the processing apparatus 120 may be configured to assess whether acceptable conditions for growing crops are met based on comparison of the luminosity, temperature and/or humidity of the greenhouse 2 to reference data, and generate the signal 122 relating to whether acceptable conditions for growing crops are met when luminosity, temperature and/or humidity at least reaches a reference value.

In this embodiment, the signal 122 generated by the processing device 120 may be directed to and transmitted to a display device 130 for conveying information to a user of the display device 130. More specifically, in this example, the display device 130 may comprise the user interface 134 (e.g., a graphical user interface) for interacting with a user and a processing entity 136 for processing the signal 122 and generate a suitable user interaction depending on the signal 122. In this embodiment, the user interface 134 comprises a display 137 for displaying the information to the user and a speaker 138 for alerting the user of a notification or an alert.

In some embodiments, the display device 130, including the user interface 134 may be part of a user interface of the greenhouse. In other embodiments, the display device 130 may a device separate from the greenhouse 2. The display device 130 may be any suitable device and may be, for instance, one of: a computer, a smartphone, a laptop, a tablet computer and a phablet, on which an app has been downloaded so as to interact with the monitoring system 100. In this example, the processing apparatus 120 may be configured to push notifications via the user interface 134 in response to the measurement of the characteristic attaining or exceeding a threshold value.

The information conveyed by the display device 130 may comprise an indication of a characteristic of the greenhouse 2 (e.g., luminosity, temperature, humidity, etc.), and/or a notification based on the characteristic of the greenhouse 2. In some cases, the monitoring system 100 may be in communication with a functional component of the panel 20, such as the LCD screen 70, the shutters 80, the lighting system 90, etc. In this example, the notification may notify of an adjustment to be made to adjust an equipment setting of the functional component of the panel 20 (such as, for example, an opacity of the LCD screen 70, an opening setting of the shutters 80, a brightness of the LED 92, etc.), indicate a magnitude of the adjustment to be made, request an authorization from the user to automatically adjust said equipment setting, notify of potential damage to the greenhouse 2 and/or the crops, etc.

In some embodiments, the panels 20 may communicate with one another, with the processing apparatus 120 and/or with the display device 130 by implementing an internet-of-things (IoT) protocol and/or a blockchain protocol.

In some embodiments, functional components of the panel 20 and/or the greenhouse 2, such as the LCD screen 70, the shutters 80, the lighting system 90, etc., which may be configured for affecting lighting characteristics of the greenhouse 2, may be in communication with the monitoring system 100 and may be responsive to control signals 124 generated by the monitoring system 100. That is, the monitoring system 100 may be a monitoring and control system in communication with the functional components of the panel 20 and/or greenhouse 2 and may be configured for generating control signals 124 conveying instructions to affect each respective functional component, and each functional component may be responsive to the control signals 124 received from the monitoring system 100 for adapting operating parameters associated with the functional component to affect the lighting characteristics of the greenhouse 2 based on said control signals 124. In particular, the processing apparatus 120 of the monitoring system 100 may be configured to generate the control signal 124 at least in part (i.e., in part or entirely) in response to a user input provided through the user interface 134 and/or at least in part based on results obtained by processing the measurement of the characteristics (e.g., in an automated fashion).

For instance, in some embodiments, the display device 130 may be configured for generating and conveying command signals 132 to the monitoring system 100 at least in part (i.e., in part or entirely) in response to a user input provided through the user interface 134 and/or at least in part based on results obtained by processing the measurement of the characteristics (e.g., in an automated fashion)The monitoring system 100 may be configured to receive the command signals 132 from the display device 130 and generate the control signals 124 in response to receiving the command signals 132.

In some embodiments, the functional component affected by the control signals 124 may include the LCD screen 70, and the control signals 124 of the monitoring system 100 may configured to modulate the opacity of the LCD screen 70. In particular, the opacity of the LCD screen 70 may be adjustable and the LCD screen 70 responsive to the controls signals 124 received from the monitoring system 100 to modulate the opacity of the panel 20 by adjusting the opacity of the screen 70.

In some embodiments, the functional component affected by the control signal 124 may include the shutters 80, and the control signal 124 of the monitoring system 100 may be configured to control the shutter-opening setting to modulate an opacity of the panels 20 and to affect the lighting characteristics of the greenhouse 2 by adjusting a current position of the adjustable shutters 80 to a desired position between the closed position and the open position.

In some embodiments, the functional component affected by the control signal 124 may and the control signal 124 of the monitoring system 100 may be configured to control the brightness level of the LEDs 92. In particular, the lighting system 90 may be responsive to the control signals 124 received from the monitoring system 100 to modulate the brightness level of the LEDs 92 to affect the lighting characteristics of the greenhouse 2.

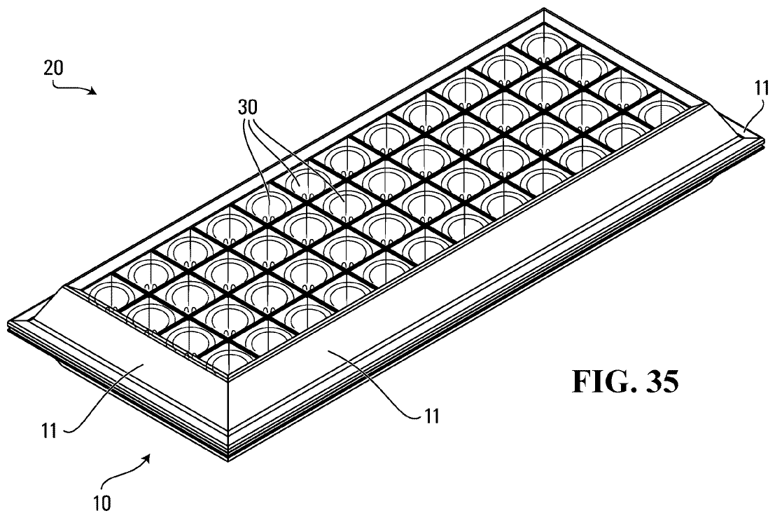

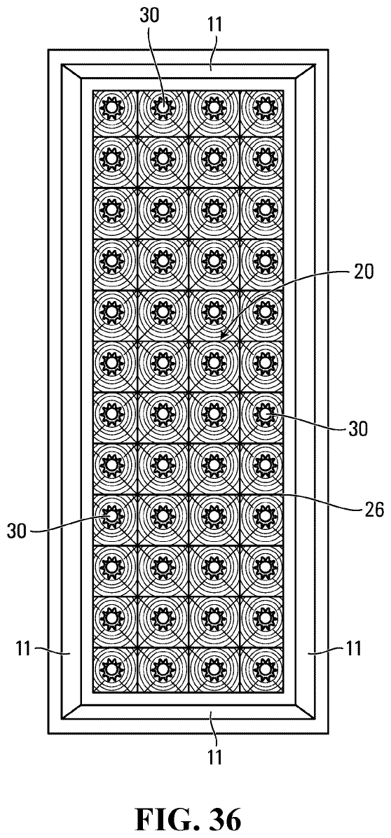

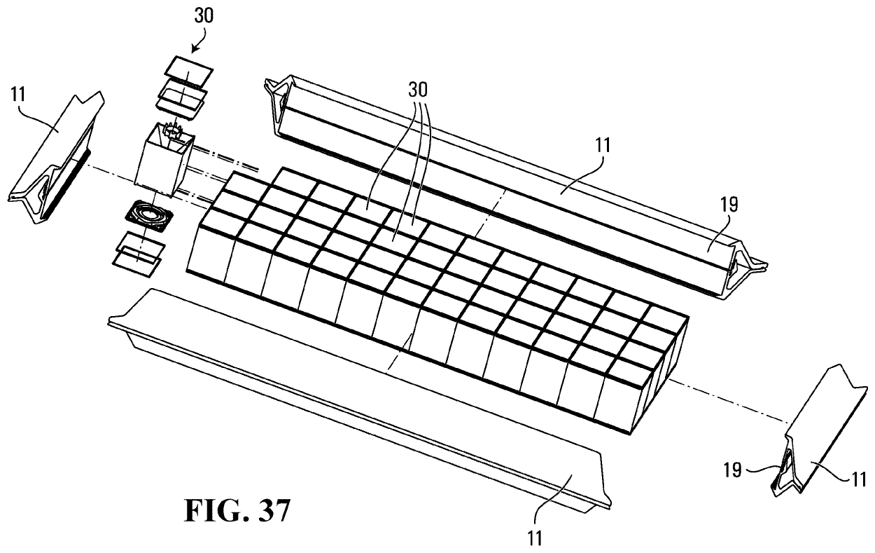

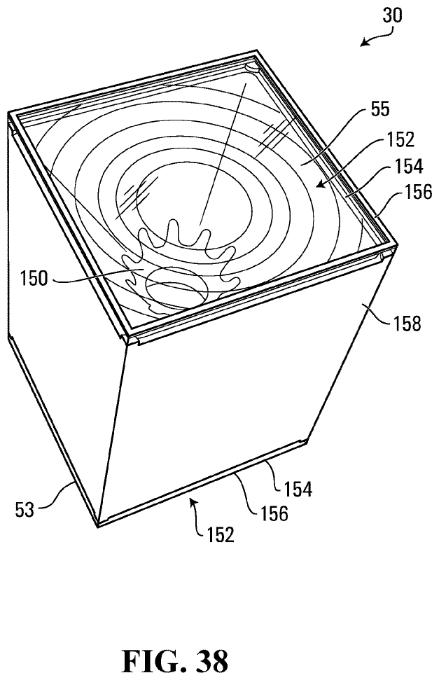

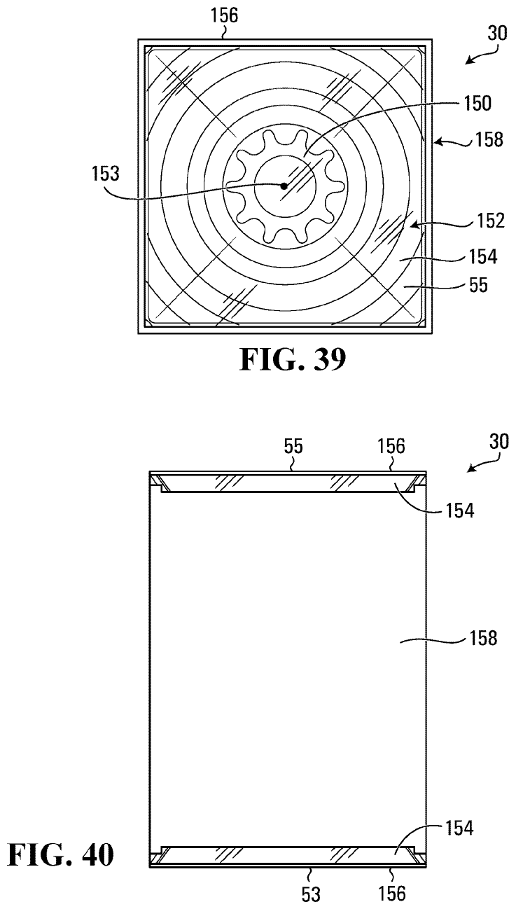

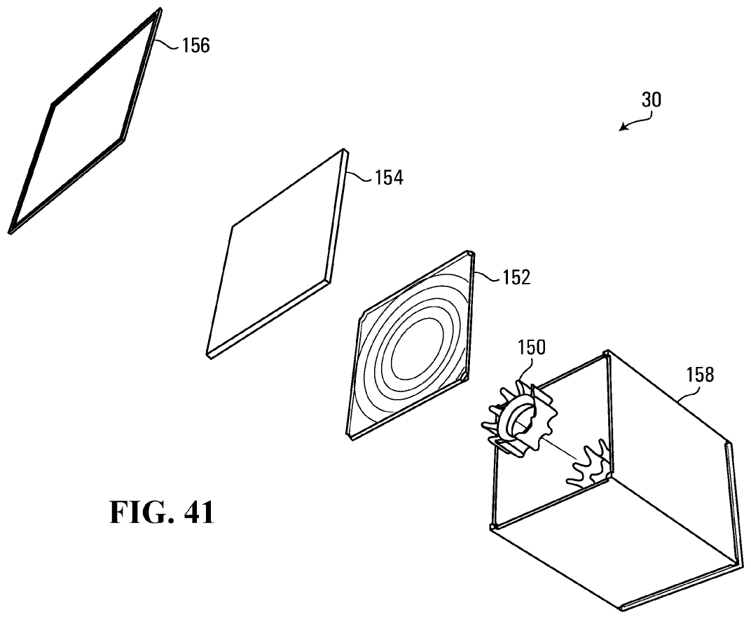

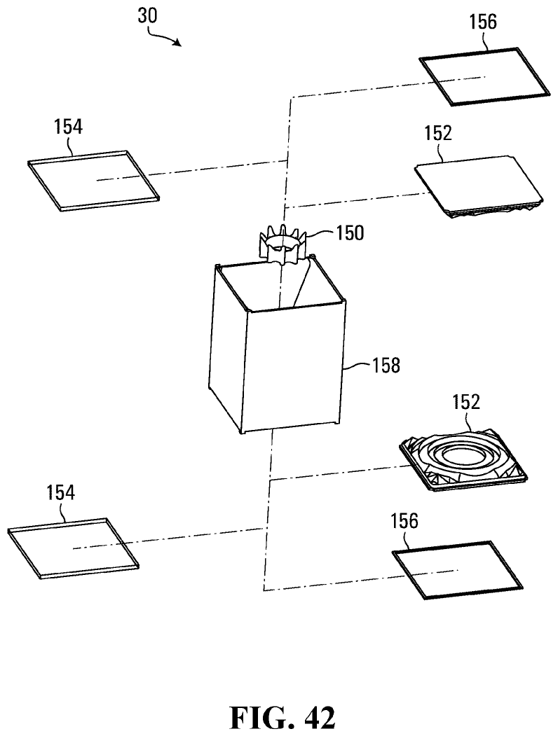

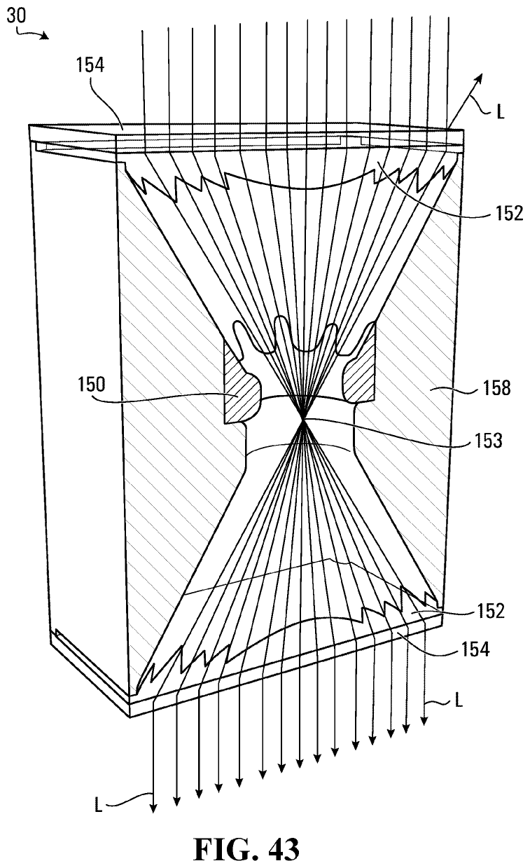

As another example, in some embodiments, as shown in FIGS. 35 to 43, the panel 20 may comprise a fewer number of light-transmitting devices 30 and each light-transmitting device 30 may have higher geometrical dimensions. For instance, in some embodiments, the panel 20 may comprise between 1 and 100 light-transmitting devices, in some embodiments between 25 and 75 light-transmitting devices, and in some embodiments about 50 light-transmitting devices, and each light-transmitting device may have a cross-section orthogonal to the thicknesswise direction TD of the panel 20 between 1 cm² and 1000cm², in some embodiments between 50 cm² and 500 cm² and in some embodiments about 100 cm²

In this embodiment, each light-transmitting device 30 may include a thermal battery 150 for storing heat, optical lenses 152 redirecting light, filters 154 for filtering light, a seal 156 for sealing the light-transmitting device 30 and a casing 158 for holding the thermal battery 150, optical lenses 152, filters 154 and seal 156 together and for providing thermal insulation.

The optical lenses 152 may be configured for converging light towards a focal point 153 which, in this embodiment, is located at a mid-point of the light-transmitting device 30 in the longitudinal, widthwise and thicknesswise directions LD, WD, TD of the light-transmitting device 30. For instance, in this embodiment, the optical lenses 152 may be Fresnel lenses. The optical lenses 152 may be made of any suitable material such as, for instance, a refractory material (e.g., a refractory glass, a refractory plastic, etc.).

The thermal battery 150 may be circular and disposed around the focal point 153 such that it accumulates heat when light pass through the focal point 153. The thermal battery 150 may comprise any suitable material having a high mass heat capacity. For instance, in some embodiments, the thermal battery 150 may comprise ceramic, concrete, cement, magnesium, aluminum, copper, steel, brass, etc.

The filters 154 may be configured reflect and/or absorb at least part of the light in a specific range of wavelengths. For instance, in some embodiments, the filters 154 may be configured to interfere with light of wavelengths between 410 nm and 510 nm and/or between 610 nm and 710 nm. The filters 154 may comprise any suitable material. For instance, in some embodiments, the filters 154 may comprise a layer of chrome paint, aluminum, barium sulphate and/or a polymeric film with a reflecting layer. In some embodiments, the filters 154 may comprise a photovoltaic cell configured to capture energy of at least part of the light in a specific range of wavelengths. In this regard, the photovoltaic cell may be connected directly or indirectly (e.g., in series with other photovoltaic cell) to a battery to store the energy captured by the photovoltaic cell. In this example, the photovoltaic cell may be translucent to light of wavelengths different from the specific range of wavelengths the filters 154 are configured to interfere with.

The seal 156 may comprise any suitable material. For instance, the seal 156 may comprise glass. In some embodiments, the seal 156 may also comprise an adhesive such as glue or silicone.

The casing 158 may have any suitable shape. For instance, in this embodiment, the casing 158 has a substantially cubic shape. In some embodiments, the casing may have a rectangular prism shape, a hexagonal prism shape, etc.

The casing 158 may comprise a material that is relatively light and that is a heat insulator. For instance, the casing 158 may comprise foam, polyurethane, rubber, expended polystyrene and/or silicone aerogel.

Although in embodiments considered above the building 2 is a greenhouse, in other embodiments, the building 2 may be another kind of industrial building (e.g., a manufacturing plant), an office tower, a residential building (e.g., an apartment building, a condo tower, a hotel), any other kind of building, a car, a truck, a ship, a plane, a spaceship, or any other kind of applicable construction.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents.

In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

1. A light-transmitting panel for a building, the light-transmitting panel comprising:
a. an inner surface, an outer surface and a perimeter surrounding the inner surface and outer surface;
b. a light-transmitting member positioned between the inner surface and the outer surface, the light-transmitting member comprising:
i. a plurality of light transmitting devices positioned alongside one-another, each light transmitting devices including a light-receiving portion, a light-emitting portion and a transmission portion between the light-receiving portion and the light-emitting portion; and
ii. a thermal insulator at least partially surrounding the light-transmitting devices in the plurality of light transmitting devices.

2. The light-transmitting panel of claim 1, wherein the light-transmitting devices in the plurality of light transmitting devices comprise light pipes.

3. The light-transmitting panel of claim 1, wherein:
a. light-receiving portions of the plurality of the light transmitting devices are positioned along the outer surface of the light-transmitting panel; and
b. light-emitting portions of the plurality of the light transmitting devices are positioned along the inner surface of the light-transmitting panel.

4. The light-transmitting panel of claim 1, wherein the light-emitting portions of the light-transmitting devices constitute at least a part of the inner surface of the panel.

5. The light-transmitting panel of claim 1, wherein the light-receiving portions of the light-transmitting devices constitute at least a part of the outer surface of the panel.

6. The light-transmitting panel of claim 1, wherein the light-receiving portion of each light-transmitting device comprises a convex outer surface configured to concentrate light towards the transmission portion of the light-transmitting device.

7.-11. (canceled)

12. The light-transmitting panel of claim 1, wherein the light-transmitting devices comprise a translucent material.

13.-15. (canceled)

16. The light-transmitting panel of claim 12, wherein the translucent material is configured to interfere with light in a first specific range of wavelengths, the translucent material further comprising an additive configured to interfere with light in the first specific range of wavelengths.

17.-38. (canceled)

39. The light-transmitting panel of claim 1, wherein a coefficient of thermal insulation of the panel is at least R5.

40.-41. (canceled)

42. The light-transmitting panel of claim 1, wherein a light transmittance for light of a desired wavelength range of the light-transmitting member of the panel is at least 50%.

43-48. (canceled)

49. The light-transmitting panel of claim 1, comprising an outer filter positioned between the outer surface of the panel and the light-transmitting member, said outer filter being configured to interfere with light in a second specific range of wavelengths.

50. The light-transmitting panel of claim 49, wherein the outer filter is configured to reflect at least part of the light in the second specific range of wavelengths, the outer filter being further configured to absorb at least part of the light in the second specific range of wavelengths.

51.-53. (canceled)

54. The light-transmitting panel of claim 49, wherein the outer filter comprises a photovoltaic cell configured to capture energy of at least part of the light in the specific second range of wavelengths.

55.-56. (canceled)

57. The light-transmitting panel of claim 1, wherein each light-transmitting device is elongate and extends along an axis, and the light-transmitting panel comprises a photovoltaic cell positioned between the outer surface of the panel and the light-transmitting member and covering an area offset relative to the axes of the light-transmitting devices.

58. (canceled)

59. The light-transmitting panel of any one of claim 1, comprising an inner filter positioned between the inner surface of the panel and the light-transmitting member, said inner filter being configured to interfere with light in a third specific range of wavelengths.

60.-108. (canceled)

109. A panel system comprising:
a plurality of light-transmitting panels for a building, each light-transmitting panel comprising:
a. an inner surface, an outer surface and a perimeter surrounding the inner surface and outer surface of the light-transmitting panel;
b. a light-transmitting member positioned between the inner surface and the outer surface, the light-transmitting member comprising:
i. a plurality of light transmitting devices positioned alongside one-another, each light transmitting device including a light-receiving portion, a light-emitting portion and a transmission portion between the light-receiving portion and the light-emitting portion; and
ii. a thermal insulator at least partially surrounding the light-transmitting devices in the plurality of light transmitting devices;
and
c. at least one sensor configured to sense a characteristic of an environment of the panel and generate a signal conveying a measurement of the characteristic; and
a monitoring system in communication with said at least one sensor, the monitoring system comprising a processing apparatus configured for:
receiving the signal conveying the measurement of the characteristic;
and
processing the signal and rendering a user interface on a display device in communication with the monitoring system, the user interface presenting information derived by processing the measurement of the characteristic.

110.-122. (canceled)

123. The panel system of claim 109, wherein each light-transmitting panel includes a functional component in communication with the monitoring system and configured for affecting lighting characteristics of the building, wherein:
a. the monitoring system is configured for generating control signals conveying instructions to affect each respective functional component of the light-transmitting panels in the plurality of light-transmitting panels;
and
b. each functional component being responsive to control signals received from the monitoring system for adapting operating parameters associated with the functional component to affect the lighting characteristics of the building based on said control signals.

124. The panel system of claim 123, wherein the processing apparatus of the monitoring system is configured to generate the control signals at least in part in response to a user input provided through the user interface and/or based on results obtained by processing the measurement of the characteristic.

125.-133. (canceled)

134. The panel system of claim 109, wherein the functional component includes adjustable shutters extending along the light-transmitting member, the shutters being configured for moving between a closed position and an open position to affect the lighting characteristics of the building, the adjustable shutters being responsive to controls signals received from the monitoring system to modulate the opacity of the panel by adjusting a current position of the adjustable shutters to a desired position between the closed position and the open position.

135. The panel system of claim 109, wherein the functional component includes a lighting system disposed inwards to the light-transmitting devices, the lighting system including one or more lighting elements and being configured to complement light emission of the light-transmitting devices.

136.-137. (canceled)

138. The panel system of claim 135, wherein the lighting system is responsive to controls signals received from the monitoring system to modulate the brightness level of the lighting elements to affect the lighting characteristics of the building.

139.-140. (canceled)

141. An electronic monitoring system for a plurality of light-transmitting panels using in a building, the light-transmitting panel comprising at least one sensor configured to sense a characteristic of an environment of the panel and generate a signal conveying a measurement of the characteristic, the monitoring system being communication with said at least one sensor for receiving the signal conveying the measurement of the characteristic, the monitoring system comprising a processing apparatus for:
receiving the signal conveying the measurement of the characteristic:
and
processing the signal and rendering a user interface on a display device in communication with the monitoring system, the user interface presenting information derived by processing the measurement of the characteristic.

142. The electronic monitoring system of claim 141, wherein each light-transmitting panel of the plurality of light-transmitting panels includes a functional component configured for affecting lighting characteristics of the building, wherein the monitoring system is configured for:
a. generating control signals conveying instructions to affect each respective functional component of the light-transmitting panels in the plurality of light-transmitting panels; and
b. each functional component being responsive to controls signals received from the monitoring system for adapting operating parameters associated with the functional component to affect the lighting characteristics of the building based on said control signals.

143. The electronic monitoring system of claim 142, wherein the processing apparatus is configured to generate the control signals at least in part in response to a user input provided through the user interface and/or based on results obtained by processing the measurement of the characteristic.

144. (canceled)

145. The electronic monitoring system of claim 141, wherein the functional component includes a screen extending over at least a portion of the inner surface of the panel, wherein an opacity of the screen is adjustable, the monitoring system being configured to issue control signals to the screen to affect the lighting characteristics of the building at least in part by adjusting the opacity of the screen.

146. The electronic monitoring system of claim 141, wherein the functional component includes adjustable shutters extending along the light-transmitting member, the shutters being configured for moving between a closed position and an open position to affect the lighting characteristics of the building, the monitoring system being configured for issuing control systems to the adjustable shutters to affect the lighting characteristics of the building by adjusting a current position of the adjustable shutters to a desired position between the closed position and the open position.

147. The electronic monitoring system of claim 141, wherein the functional component includes a lighting system disposed inwards to the light-transmitting devices, the lighting system including one or more lighting elements having an adjustable brightness and being configured to complement light emission of the light-transmitting devices, the monitoring system being configured for issuing control systems to the lighting system to affect the lighting characteristics of the building by adjusting the brightness of the one or more lighting elements.

148.-150. (canceled)
